(19) United States
(12) Patent Application Publication
(10) Pub. No.: US 2012/0113476 A1
(43) Pub. Date: May 10, 2012

(54) PRINTING APPARATUS, COLOR CONVERSION METHOD, PROGRAM, AND RECORDING MEDIUM

(75) Inventors: Seishin YOSHIDA, Azumino-shi (JP); Mitsuhiro YAMASHITA, Matsumoto-shi (JP)

(73) Assignee: SEIKO EPSON CORPORATION, Tokyo (JP)

(21) Appl. No.: 13/293,961

(22) Filed: Nov. 10, 2011

(30) Foreign Application Priority Data
Nov. 10, 2010 (JP) 2010-252197

(51) Int. Cl. G06F 15/00

(52) U.S. Cl. 358/2.1

(57) ABSTRACT

A printing apparatus prints an image with the use of a luster agent and a colorant, and is provided with a color conversion unit which converts a color of an image into a printed color expressed by the luster agent and the colorant such that a degree of change in brightness with respect to a gradation change for pixels belonging to a highlighted part, in which index values relating to the brightness are equal to or greater than a first predetermined value, is greater than that for pixels with index values which do not belong to the highlighted part, among the pixels constituting the image.

Priority is claimed under U.S.C. §119 to Japanese Application No. 2010-252197 filed on Nov. 10, 2010 which is hereby incorporated by reference in its entirety.

### BACKGROUND

1. Technical Field

The present invention relates to a printing technique for performing printing with the use of a luster agent and a colorant.

2. Related Art

In recent years, a technique for printing an image with metallic color with various tones with the use of inks (metallic ink) which express the sense of metallic luster has been proposed. For example, a printing technique in which a layer of a metallic ink is formed on a printing medium and a color ink is superimposed thereon has been proposed (JP-A-2007-50555). In addition, a printing technique in which a layer of color ink is formed on a transparent printing medium and metallic ink is superimposed thereon has been proposed (JP-A-2001-1560). According to such a technique, an image depicted by the color ink layer is observed from a surface opposite to a printing surface of the transparent printing medium, and therefore, the metallic ink is a base when viewed from an observer.

When a printing technique in which metallic ink and color ink are superimposed is used, for example, the duty of color ink is lowered by the amount corresponding to the usage of the metallic ink in an ink-jet printer. Therefore, a luster expression effect (shiny effect) of the metallic layer in a bright region (highlighted region), in which the amount of the color ink is small, in the image is felt to be relatively high. For this reason, it becomes difficult to visually recognize the color of the color ink layer due to such a luster expression effect. In addition, the degrees of change in brightness and saturation (gradation reproducibility) with respect to the change in gradation of a pixel are lowered. In addition, there is a problem in that the increasing degree of the brightness is lowered and the gradation reproducibility is lowered in the highlighted region even if the amount of the color ink is lowered since the brightness of the metallic ink itself is relatively low (dark).

The above problem is not a problem only in the metallic ink containing metallic pigments expressing the sense of metallic luster but a common problem for an arbitrary luster agent expressing the sense of luster such as ink containing pigments expressing the sense of luster similar to the pearly luster or the like, for example. In addition, the above problem is not a problem only in an ink-jet printer but a common problem in various printing apparatuses for printing with the use of the luster agent and the colorant.

### SUMMARY

An advantage of some aspects of the invention is to suppress lowering in the gradation reproducibility in a highlighted region of an image in a printing apparatus for printing with the use of the luster agent and the colorant.

The invention was made to solve at least a part of the above problem and can be realized as the following embodiments or the applications.

### Application 1

According to an aspect of the invention, there is provided a printing apparatus which prints an image with the use of a luster agent and a colorant, including: a color conversion unit which converts a color of an image into a printed color expressed by the luster agent and the colorant such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

According to the printing apparatus of the application 1, a color of an image is converted into a printed color such that a degree of change in brightness with respect to a gradation change for pixels belonging to a highlighted part in which index values relating to the brightness are equal to or greater than a first predetermined value is greater than that for pixels which do not belong to the highlighted part. Therefore, it is possible to set the degree of change in brightness with respect to the gradation degree to be high in the highlighted region of the image. For this reason, it is possible to suppress lowering of gradation reproducibility in the highlighted region in the obtained image when the printing is performed with the printing apparatus which performs printing with the use of the luster agent and the colorant according to the printing apparatus of the application 1.

### Application 2

In the printing apparatus of the application 1, the color conversion unit converts the color of the image into the printed color with the use of a color conversion LUT which sets the degree of change in brightness with respect to the gradation change for the pixels with the index values which belong to the highlighted part to be larger than that for the pixels with the index values which do not belong to the highlighted region, among the pixels constituting the image.

With such a configuration, it is possible to convert the color of the image into the printed color such that the degree of change in brightness with respect to the gradation change for the pixels with the index values which belong to the highlighted part is larger than that for the pixels with the index values which do not belong to the highlighted part by performing the color conversion with the use of the color conversion LUT. In addition, the color conversion LUT is set in advance so as to convert the color of the image into the printed color such that the degree of change in brightness with respect to the gradation change for the pixels with index values which belong to the highlighted part is larger than that for the pixels with the index values which do not belong to the highlighted part. Therefore, it is not necessary to adjust the degree of change in brightness with respect to the gradation change for the pixels constituting an image every time an image is printed, and thereby to shorten the time required for printing.

### Application 3

In the printing apparatus of the application 1, the color conversion unit includes: a brightness adjustment unit which sets the degree of change in brightness with respect to the gradation change for the pixels with index values which belong to the highlighted region to be larger than that for the pixels with index values which do not belong to the highlighted region, among the pixels constituting the image; a color conversion LUT which associates the color of the image with the printed color; and a conversion unit which converts the color of the image which has been adjusted by the brightness conversion unit into the printed color with the use of the color conversion LUT.

With such a configuration, it is possible to convert the color of the image into the printed color such that the degree of change in brightness with respect to the gradation change for the pixels with index values which belong to the highlighted part is larger than that for pixels with index values which do not belong to the highlighted part. In addition, it is possible to use an existing LUT for the printing apparatus, in which the degree of change in brightness with respect to the gradation change has not been adjusted, as the color conversion LUT. Therefore, it is possible to easily update the LUT when the LUT is updated.

### Application 4

In the printing apparatus of any one of the applications 1 to 3, the color conversion unit converts the color of the image into the printed color such that an amount of the luster agent for pixels belonging to a shadow part in which the index values are equal to or less than a second predetermined value which is less than the first predetermined value is smaller than that for the pixels with the index values which do not belong to the shadow part, among the pixels constituting the image.

With such a configuration, it is possible to reduce the use amount of the luster agent in the shadow region (relatively dark region) in the image. Since the use amount of the colorant is increased, the luster expression effect by the luster agent is relatively small in the shadow region. Therefore, it is possible to effectively reduce the use amount of the luster agent. In addition, when the printing apparatus is an ink-jet printer, the use amount of the colorant is further restricted by the use amount of the luster agent due to the problems such as colorant bleed and the like. As a result, it is possible to suppress such a problem while a color reproductive range becomes narrower in the shadow region in which the use amount of the colorant is large.

### Application 5

According to another aspect of the invention, there is provided a printing apparatus which prints an image with the use of a luster agent and a colorant, including: a color conversion unit which converts a color of an image into a printed color expressed by the luster agent and the colorant such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

According to the printing apparatus of the application 5, the color of the image is converted into the printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part. Therefore, it is possible to increase the change decree in saturation with respect to the gradation change in the highlighted region of the image. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when the printing is performed with the printing apparatus which performs printing with the use of the luster agent and the colorant according to the printing apparatus of the application 5.

### Application 6

In the printing apparatus of the application 5, the color conversion unit converts the color of the image into the printed color with the use of a color conversion LUT which sets the degree of change in saturation with respect to the gradation change for the low saturation pixels to be larger than that for the pixels with the index values which do not belong to the highlighted region, among the pixels constituting the image.

With such a configuration, it is possible to convert the color of the image into the printed color such that the degree of change in saturation with respect to the gradation change for the low saturation pixels is larger than that for the pixels with the index values which do not belong to the highlighted part by performing the color conversion with the use of the color conversion LUT. In addition, the color conversion LUT is set in advance so as to convert the color of the image into the printed color such that the degree of change in saturation with respect to the gradation change for the low saturation pixels is larger than that for the pixels with the index values which do not belong to the highlighted part. Therefore, it is not necessary to adjust the degree of change in saturation with respect to the gradation change for the pixels constituting an image every time an image is printed, and thereby to shorten the time required for printing.

### Application 7

In the printing apparatus of the application 5, the color conversion unit includes: a saturation adjustment unit which sets the degree of change in saturation with respect to the gradation change for the low saturation pixels to be larger than that for the pixels with index values which do not belong to the highlighted region, among the pixels constituting the image; a color conversion LUT which associates the color of the image with the printed color; and a conversion unit which converts the color of the image which has been adjusted by the saturation adjustment unit into the printed color with the use of the color conversion LUT.

With such a configuration, it is possible to convert the color of the image into the printed color such that the degree of change in saturation with respect to the gradation change for the pixels with index values which belong to the highlighted part is larger than that for pixels with index values which do not belong to the highlighted part. In addition, it is possible to use an existing LUT for the printing apparatus, in which the degree of change in saturation with respect to the gradation change has not been adjusted, as the color conversion LUT. Therefore, it is possible to easily update the LUT when the LUT is updated.

### Application 8

In the printing apparatus of any one of the applications 5 to 7, the color conversion unit converts the color of the image into the printed color such that an amount of the luster agent for pixels belonging to a shadow part in which the index values are equal to or less than a second predetermined value which is less than the first predetermined value is smaller than that for the pixels with the index values which do not belong to the shadow part, among the pixels constituting the image.

With such a configuration, it is possible to reduce the use amount of the luster agent in the shadow region (relatively dark region) in the image. Since the use amount of the colorant is increased, the luster expression effect by the luster agent is relatively small in the shadow region. Therefore, it is possible to effectively reduce the use amount of the luster agent. In addition, when the printing apparatus is an ink-jet printer, the use amount of the colorant is further restricted by the use amount of the luster agent due to the problems such as colorant bleed and the like. As a result, it is possible to suppress such a problem while a color reproductive range becomes narrower in the shadow region in which the use amount of the colorant is large.

### Application 9

According to still another aspect of the invention, there is provided a printing control apparatus which controls a printing apparatus which prints an image with the use of a luster agent and a colorant, the printing control apparatus including: a color conversion unit which converts a color of an image into a printed color expressed by the luster agent and the colorant such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

In the printing control apparatus of the application 9, the color of the image is converted into the printed color such that the degree of change in brightness with respect to the gradation change for the pixels belonging to the highlighted part in which the index values relating to brightness are equal to or greater than the first predetermined value, is larger than that for the pixels which do not belong to the highlighted part. Therefore, it is possible to increase the degree of change in brightness with respect to the gradation change in the highlighted region of the image. For this reason, it is possible to suppress the lowering of the gradation reproducibility in the highlighted region of the obtained image when the printing is performed with the printing apparatus which performs printing with the use of the luster agent and the colorant according to the printing control apparatus of the application 9.

### Application 10

According to still another aspect of the invention, there is provided a printing control apparatus which controls a printing apparatus which prints an image with the use of a luster agent and a colorant, the printing control apparatus including: a color conversion unit which converts a color of an image into a printed color expressed by the luster agent and the colorant such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

According to the printing control apparatus of the application 10, the color of the image is converted into the printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part. Therefore, it is possible to increase the change decree in saturation with respect to the gradation change in the highlighted region of the image. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when the printing is performed with the printing apparatus which performs printing with the use of the luster agent and the colorant according to the printing control apparatus of the application 10.

### Application 11

According to still another aspect of the invention, there is provided a color conversion method by which a color of an image is converted into a printed color expressed by a luster agent and a colorant used in a printing apparatus, the method including: converting a color of an image into a printed color such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

In the color conversion method of the application 11, the color of the image is converted into the printed color such that the degree of change in brightness with respect to the gradation change for the pixels belonging to the highlighted part in which the index values relating to brightness are equal to or greater than the first predetermined value, is larger than that for the pixels which do not belong to the highlighted part. Therefore, it is possible to increase the degree of change in brightness with respect to the gradation change in the highlighted region of the image printed by the printing apparatus. For this reason, it is possible to suppress the lowering of the gradation reproducibility in the highlighted region of the obtained image when the printing is performed with the printing apparatus which performs printing with the use of the luster agent and the colorant according to the color conversion method of the application 11.

### Application 12

According to still another aspect of the invention, there is provided a color conversion method by which a color of an image is converted into a printed color expressed by a luster agent and a colorant used in a printing apparatus, the method including: converting a color of an image into a printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

In the color conversion method of the application 12, the color of the image is converted into the printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part. Therefore, it is possible to increase the change decree in saturation with respect to the gradation change in the highlighted region of the image printed by the printing apparatus. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when the printing is performed with the printing apparatus which performs printing with the use of the luster agent and the colorant according to the color conversion method of the application 12.

### Application 13

According to still another aspect of the invention, there is provided a program by which a color of an image is converted into a printed color expressed by a luster agent and a colorant used in a printing apparatus, the program causing a computer to execute: converting a color of an image into a printed color such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

According to the program of the application 13, the color of the image is converted into the printed color such that the degree of change in brightness with respect to the gradation change for the pixels belonging to the highlighted part in which the index values relating to brightness are equal to or greater than the first predetermined value, is larger than that for the pixels which do not belong to the highlighted part. Therefore, it is possible to increase the degree of change in brightness with respect to the gradation change in the highlighted region of the image. For this reason, it is possible to suppress the lowering of the gradation reproducibility in the highlighted region of the obtained image when the printing is performed with the printing apparatus which performs printing with the use of the luster agent and the colorant according to the program of the application 13.

### Application 14

According to still another aspect of the invention, there is provided a program by which a color of an image is converted into a printed color expressed by a luster agent and a colorant used in a printing apparatus, the program causing a computer to execute: converting a color of an image into a printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

According to the program of the application 14, the color of the image is converted into the printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part. Therefore, it is possible to increase the change decree in saturation with respect to the gradation change in the highlighted region of the image printed by the printing apparatus. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when the printing is performed with the printing apparatus which performs printing with the use of the luster agent and the colorant according to the program of the application 14.

### Application 15

According to still another aspect of the invention, there is provided a computer readable recording medium which records the program of the application 13 or 14.

With such a configuration, it is possible to cause a computer to read the program and realize each function with the use of such a recording medium.

In addition, the invention can be realized in various manners such as in color conversion LUT, a color conversion LUT generating method, a computer program for LUT generation, a recording medium recording the computer program thereon, and the like.

### BRIEF DESCRIPTION OF THE DRAWINGS

The invention will be described with reference to the accompanying drawings, wherein like numbers reference like elements.

FIG. 1 is a configuration diagram schematically showing a printer as an embodiment of the invention.

FIG. 2 is a flowchart of printing processing in the embodiment.

FIG. 3 is a flowchart showing a procedure of producing a LUT shown in FIG. 1.

FIG. 4 is an explanatory diagram schematically showing contents of setting of a brightness adjustment LUT shown in FIG. 1.

FIG. 5 is an explanatory diagram showing a procedure of printing processing according to a second embodiment.

FIG. 6 is a configuration diagram schematically showing a printer according to a third embodiment.

FIG. 7 is a flowchart showing a procedure of second LUT producing processing according to the third embodiment.

FIG. 8 is an explanatory diagram showing contents of setting of a saturation adjustment LUT shown in FIG. 6.

FIG. 9 is a flowchart of printing processing according to the third embodiment.

FIG. 10 is a flowchart showing a procedure of LUT producing processing according to a fourth embodiment.

FIG. 11 is an explanatory diagram schematically showing an RGB color space relating to an input value of a printer according to the fourth embodiment.

FIG. 12 is an explanatory diagram showing a relationship between each color gradation of a single color patch and a superimposed color patch in a color line CL1 and L* measured in Step S235.

FIG. 13 is an explanatory diagram showing a relationship between each color gradation and L* in a color line CL4.

FIG. 14 is a first flowchart showing a procedure of LUT producing processing according to a fifth embodiment.

FIG. 15 is a second flowchart showing a procedure of LUT producing processing according to the fifth embodiment.

FIG. 16 is an explanatory diagram schematically showing a method of setting a metallic ink reduced region according to the fifth embodiment.

FIG. 17 is an explanatory diagram schematically showing a method of determining an ellipsoidal spherical shape shown in FIG. 16.

FIGS. 18A and 18B are explanatory diagrams schematically showing a method of determining whether or not a lattice point of a LUT is included in a metallic ink reduced region.

FIG. 19 is an explanatory diagram schematically showing an amount of metallic ink observed on a printing medium when an image obtained by color conversion with the use of a LUT is printed.

FIG. 20 is an explanatory diagram schematically showing a method of setting a metallic ink reduced region according to a sixth embodiment.

FIGS. 21A and 21B are explanatory diagrams schematically showing a method of determining whether or not a lattice point of a LUT according to the sixth embodiment is included in a metallic ink reduced region.

FIG. 22 is an explanatory diagram schematically showing a method of setting a metallic ink reduced region according to a seventh embodiment.

FIG. 23 is an explanatory diagram showing contents of setting of a table used for determining an amount of metallic ink in a modified example 1.

FIG. 24 is an explanatory diagram showing an application of the invention to a computer according to a modified example 12.

FIGS. 25A and 25B are explanatory diagrams schematically showing a method of setting an amount of metallic ink for a lattice point included in a metallic ink reduced region according to a modified example 13.

### DESCRIPTION OF EXEMPLARY EMBODIMENTS

### A. First Embodiment

### A1. Configuration of Printing Apparatus

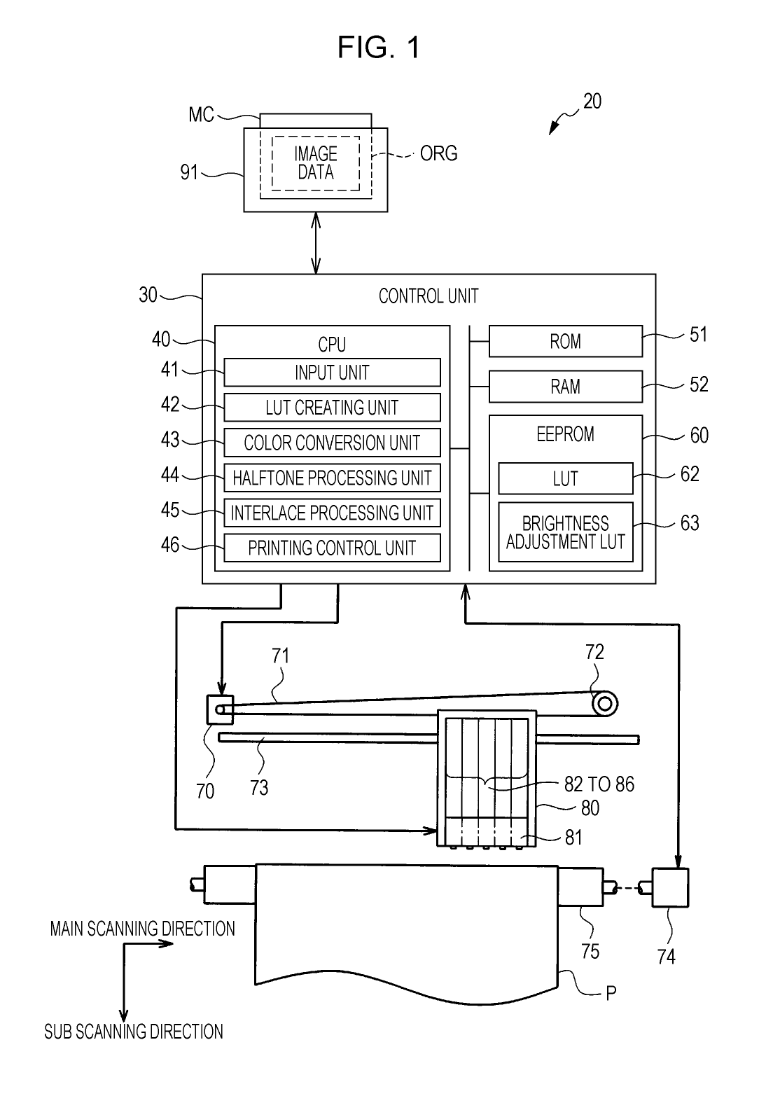

FIG. 1 is a configuration diagram schematically showing a printer according to an embodiment of the invention. A printer 20 is an ink-jet printer including a mechanism which transports a printing medium P by a sheet feeding motor, a mechanism which reciprocates carriage 80 in an axial direction of a platen 75 by a carriage motor 70, a mechanism which drives a print head 81 mounted on the carriage 80 to discharge ink and form dots, and a control unit 30 which manages the signal communication with the sheet feeding motor 74, the carriage motor 70, and the print head 81.

The mechanism which reciprocates the carriage 80 in the axial direction of the platen 75 is stretched so as to be parallel to the axis of the platen 75 and includes a sliding axis 73 which slidably holds the carriage 80, a pulley 72 which stretches an endless driving belt 71 to the carriage motor 70, and the like.

On the carriage 80, ink cartridges 82 to 85 for color ink, which contain cyan ink C, magenta ink M, yellow ink Y, and black ink K, respectively, are mounted. In addition, an ink cartridge 86 for metallic ink which contains metallic ink S is mounted on the carriage 80. Nozzle arrays corresponding to the aforementioned each color ink and the metallic ink S are formed on the print head 81 under the carriage 80. It is possible to supply ink from each cartridge to the print head 81 by mounting such ink cartridges 82 to 86 on the carriage 80 from the upper direction.

In addition, the “color ink” in this embodiment means a concept including the black ink. Moreover, pigment ink is used as the color ink in this embodiment.

In addition, the metallic ink is ink with which a printed material expresses a metallic sense, and it is possible to use an oil-based ink composition containing metallic pigments, organic solvent, and resin, for example, as the metallic ink. The aforementioned metallic pigments are preferably plate-shaped particles in order to effectively generate a visually metallic texture. When it is assumed that X represents the longer diameter on a plane of the plate-shaped particle, Y represents the shorter diameter, and Z represents the thickness, it is preferable that a 50% average particle diameter R50 of a diameter of a circle obtained from an area of an X-Y plane of the plate-shaped particle ranges from 0.5 to 3 μm and satisfies a condition of R50/Z>5. Such metallic pigments can be formed by aluminum or aluminum alloy, and it is also possible to create the metallic pigments by crushing a metal deposited film. The density of the metallic pigments contained in the metallic ink can be set to 0.1 to 10.0% by weight. It is matter of course that the metallic ink is not limited to such a composition, and it is also possible to appropriately employ another composition as long as the composition can generate a metallic sense.

In this embodiment, the composition of the metallic ink S contains 1.5% by weight of aluminum pigments, 20% by weight of glycerin, 40% by weight of triethylene glycol monobutyl ether, and 0.1% by weight of BYK-UV3500 (manufactured by BYK Additives & Instruments).

The control unit 30 has a configuration in which a CPU 40, a ROM 51, a RAM 52, and an EEPROM 60 are connected to each other via a bus. In addition, a memory card slot 91 is connected to the control unit 30. The memory card slot 91 contains a memory card MC which records image data ORG. In this embodiment, the image data ORG is data including three color components of red (R), green (G), and blue (B).

The CPU 40 develops and executes a program stored on the ROM 51 or the EEPROM 60 in the RAM 52 to function as an input unit 41, a LUT creating unit 42, a color conversion unit 43, a halftone processing unit 44, an interlace processing unit 45, and a print control unit 46.

The input unit 41 reads the image data ORG from the memory card MC inserted into the memory card slot 91. The LUT creating unit 42 executes the LUT creating processing which will be described later. The color conversion unit 43 converts the image data ORG (R, G, B) into the data of ink colors (CMYKS). The halftone processing unit 44 executes the halftone processing. The interlace processing unit 45 performs the interlace processing for rearranging the data into dot pattern data to be printed in units of one main scanning. The print control unit 46 controls the reciprocation of the carriage 80 and sheet feeding and drives the print head 81 to control the discharge of ink to the printing medium P.

The EEPROM 60 stores a look up table (LUT) 62. The LUT 62 is a table which associates the input value in the form of RGB with the output value in the form of CMYKS. In addition, the EEPROM 60 stores brightness adjustment LUT 63. In addition, the detail of the brightness adjustment LUT 63 will be described later.

The printer 20 with the hardware configuration as described above drives the carriage motor 70 to cause the print head 81 to reciprocate with respect to the printing medium P in the main scanning direction and drives the sheet feeding motor 74 to move the printing medium P in the sub scanning direction. The control unit 30 (print control unit 46) drives the nozzles at appropriate timing based on the print data in accordance with the reciprocation of the carriage 80 (main scanning direction) and the sheet feeding movement of the printing medium (sub scanning direction) to form ink dots with appropriate colors at appropriate positions on the printing medium P. In so doing, the printer 20 can perform metallic printing (printing of the mixture including dots of the color ink and dots of the metallic ink) of an image based on the image data ORG input from the memory card MC.

The printer 20 can suppress the lowering of the gradation reproducibility in the bright region (highlighted region) in the image when the printing is performed with the metallic ink S in addition to the color ink, by performing the color conversion with the use of the LUT 62 created in the LUT creating processing which will be described later. In addition, the aforementioned color conversion unit 43 and the LUT 62 correspond to the color conversion unit 43 in the appended claims.

### A2. Printing Processing

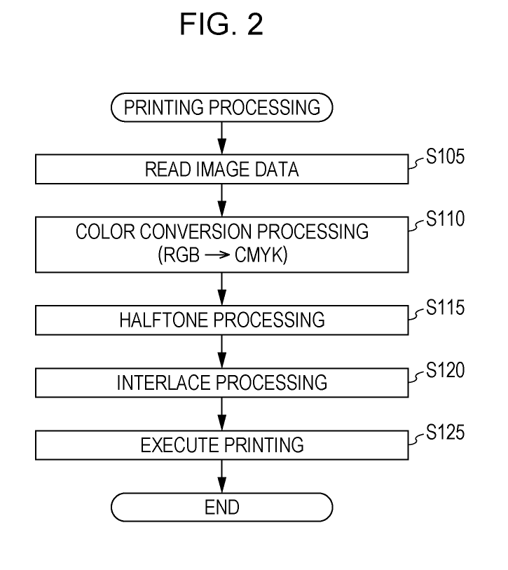

FIG. 2 is a flowchart of the printing processing according to this embodiment. When the user instructs the printing processing on the operation panel not shown in the drawing, the printing processing is started in the printer 20. The input unit 41 reads the image data ORG of the RGB format as a print target from the memory card MC via the memory card slot 91 (Step S105).

The color conversion unit 43 converts the image data ORG into the image data in the CMYK format which can be expressed by the printer 20 based on the LUT 62 stored on the EEPROM 60 (Step S110). In addition, the LUT 62 may be stored on another recording medium such as a hard disk drive provided in the printer 20, for example, which is not shown in the drawing, or may be configured to be downloaded from a computer or the like connected to the printer 20, which is not shown in the drawing.

The halftone processing unit 44 performs the halftone processing which is for converting the image data, which has been subjected to the color conversion processing, into ON/OFF data of dots of each color (Step S115). At this time, the halftone processing unit 44 uniformly sets the ink duty of the metallic ink S for all pixels to 30%. The ink duty of the metallic ink S is set to 30% because it is possible to visually recognize the metallic sense expressed by the metallic ink S to the maximum extent at the ink duty of 30% under the printing conditions of this embodiment.

As a specific method of the halftone processing, it is possible to employ a known method such as an ordered dither method, an error diffusion method, a density pattern method, and the like, for example. The interlace processing unit 45 performs the interlace processing (Step S120). When the interlace processing is performed, the print control unit 46 drives the carriage motor 70, the sheet feeding motor 74, and the print head 81 based on the dot pattern data, causes the print head 81 to discharge the metallic ink S and the color ink, and executes the metallic printing (Step S125).

At this time, it is possible to employ a printing scheme (front printing) in which the metallic ink S is firstly discharged to form the metallic ink layer and the color ink is then discharged on the metallic layer to form the color ink layer. Such front printing is printing on the assumption that an observer observes the image on the side of the color ink. In addition, it is also possible to employ a printing scheme (back printing) in which the color ink layer is firstly formed and the metallic ink S is then discharged on the color ink layer to form the metallic ink layer. Such back printing is printing on the assumption that the printing medium P is transparent and the observer observes the image from the side opposite to the printed surface of the printing medium P.

In both printing schemes, it is possible to employ a method of firstly discharging the metallic ink S or the color ink on the entire surface of the printing medium P and then discharging the color ink or the metallic ink on the entire surface of the printing medium P. In addition, it is possible to employ another method for the front printing. For example, the nozzle array of each color is divided into the upstream side nozzle group and the downstream side nozzle group along the sheet feeding direction of the printing medium P. Then, the metallic ink S is discharged from the upstream side nozzle group for the metallic ink S while the color ink is discharged from the downstream side nozzle group for the color ink at a certain pass. The printing medium P is transported by a distance corresponding to the nozzle group. Then, the metallic ink S and the color ink are discharged in the same manner at the subsequent pass. The above operations are repeatedly performed. In addition, the same method can be employed for the back printing.

### A3. LUT Creating Processing

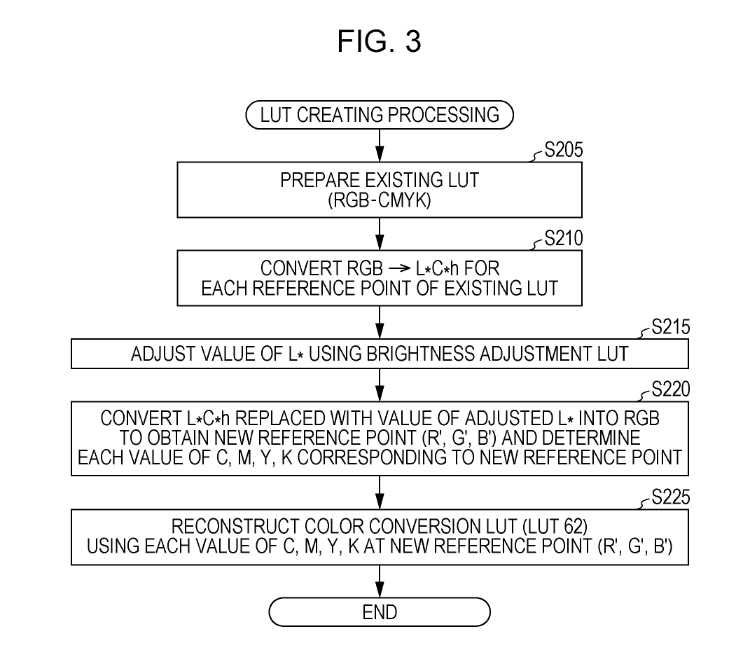

FIG. 3 is a flowchart showing a procedure of creating the LUT shown in FIG. 1. The creation of the LUT 62 can be executed before the shipping of the printer 20. Alternatively, it is also possible for a user to execute the creation of the LUT 62 at arbitrary timing at the time of initial activation of the printer 20 or after the initial activation.

First, an existing LUT for the printer 20 is prepared (Step S205). In this embodiment, the existing LUT means a LUT in which a correspondence relationship between the value in the RGB format (input value) and the value in the CMYK format (output value) is described (that is, the LUT in which the output value of the metallic ink S is not described). As such a LUT, it is possible to use a LUT in which each value of C, M, Y, K is set in association with each of seventeen reference points which are arranged at equal intervals on each axis of R, G, B, for example.

The existing LUT is a LUT used as a base for creating the LUT 62 to be used for printing while the color ink and the metallic ink S are superimposed. Therefore, the existing LUT is a LUT created by reducing the ink duty restriction value for the color ink by an amount corresponding to the metallic ink S to be superimposed, as compared with the ordinary LUT created under the condition that the metallic ink S is not included in the output value. The ink duty restriction value of the color ink is an upper limit value of the total amount of the color ink which can be discharged into a unit area of the printing medium. According to an ink-jet printer, ink bleed occurs and preferable color expression cannot be performed when a large amount of ink is discharged into a unit area of the printing medium, and therefore such restriction is provided. In addition, the ink duty restriction value becomes different based on the printing conditions such as types of a printing medium, ink, and the like.

The LUT creating unit 42 converts R, G, B for each reference point in the existing LUT prepared in Step S205 (points for which the correspondence relationship between R, G, B and C, M, Y, K is defined) into L* (brightness), C* (saturation), and h (hue angle) (Step S210). Such color space conversion can be performed by a known method such as a method of converting sRGB (standard RGB) into L*C*h, a method of converting AdobeRGB into L*C*h, and the like.

The LUT creating unit 42 adjust the value of L* (brightness) of each reference point with the use of the brightness adjustment LUT 63 shown in FIG. 1 (Step S215).

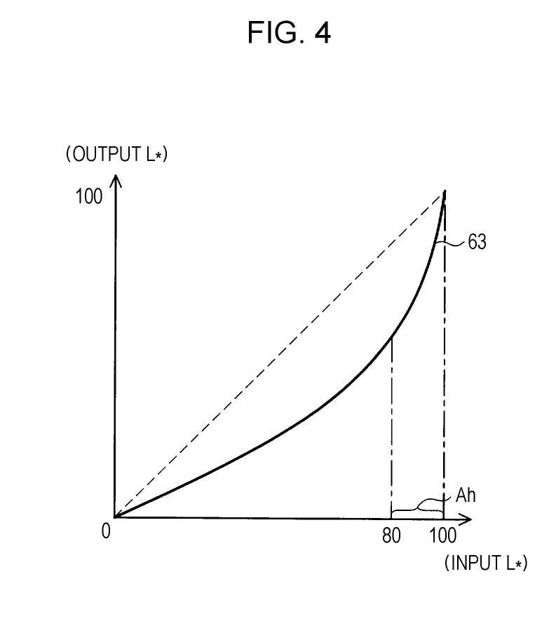

FIG. 4 is an explanatory diagram schematically showing contents of setting of the brightness adjustment LUT shown in FIG. 1. In FIG. 4, the horizontal axis represents the input value L* while the vertical axis represents the output value L*. In FIG. 4, a thick solid line schematically shows the brightness adjustment LUT 63. The brightness adjustment LUT 63 is a LUT for converting the input L* value into the output L* value.

As shown in FIG. 4, the increasing degree of the output L* value with respect to the increase in the input L* value in the highlighted part Ah (80≦L*≦100) is set to be higher than the increasing degree of the output L* value with respect to the increase in the input L* value in the region other than the highlighted part Ah in the brightness adjustment LUT 63. In addition, the increasing degree of the output L* value with respect to the increase in the input L* value is set to be higher than the increasing degree of the output L* value with respect to the increase in the input L* value before the brightness adjustment (the inclination of a straight line shown by a broken line) in the highlighted part Ah.

Next, the LUT creating unit 42 replaces L* among the values L*C*h of each reference point obtained in Step S210 with L* adjusted in Step S215, converts the replaced L*C*h into RGB to obtain a new adjusted reference point (R′, G′, B′), and determines values (amounts of ink) of C, M, Y, K corresponding to the new reference points (R′, G′, B′) (Step S220). As described above, the increasing degree of the output L* with respect to the input L* value is high in the highlighted part Ah. Therefore, the new reference point is determined such that the difference in brightness per one gradation level becomes greater for the reference point belonging to the highlighted part Ah (that is, the reference point at which the L* value satisfies 80≦L*≦100). The amounts of ink C, M, Y, K corresponding to the new reference point can be obtained by interpolating computation based on the amounts of ink at each reference point in the existing LUT, for example.

Next, the LUT creating unit 42 writes in the LUT 62 that values of C, M, Y, K at the calculated new reference point (R′, G′, B′) are to be used as amounts of ink at the reference point (R, G, B) in the color conversion LUT (LUT 62) and reconstructs the color conversion LUT (LUT 62) (Step S225).

In the thus obtained LUT 62, the differences in brightness of the ink colors (values of C, M, Y, K) associated with two adjacent reference points (that is, the differences in brightness of the ink colors per one gradation level) at the reference point belonging to the RGB color space regions corresponding to the highlighted part Ah is greater than that at the reference points belonging to the region other than the RGB color space.

If the color conversion is performed on the input image in the aforementioned Step S110 with the use of such a LUT 62, the increasing degree of L* of the color obtained in the actual printing with respect to the increase in the L* value of the input pixel belonging to the highlighted part Ah (the pixels with the L* value satisfying 80≦L*≦100) becomes greater than that of the input pixel which does not belong to the highlighted part Ah. Accordingly, the gradation reproducibility is enhanced in the bright region in the printed image.

As described above, the LUT set such that the differences in brightness of the ink colors per one gradation level of the input pixel belonging to the highlighted part Ah are greater than the differences in brightness of the ink color per one gradation level of the input pixel which does not belong to the highlighted part Ah is used as the LUT 62 for color conversion in the printer 20 according to the first embodiment. Therefore, it is possible to enhance the gradation reproducibility by the color ink in the highlighted region in the printed image. Accordingly, it is possible to suppress the lowering of the gradation reproducibility in the highlighted region in the printed image even for the printing with the use of the metallic ink S in addition to the color ink.

In addition, it is not necessary to adjust the LUT 62 every time the printing is performed and thereby to shorten the period necessary for printing since the LUT 62 is set in advance to enhance the gradation reproducibility by the color ink in the highlighted region.

### B. Second Embodiment

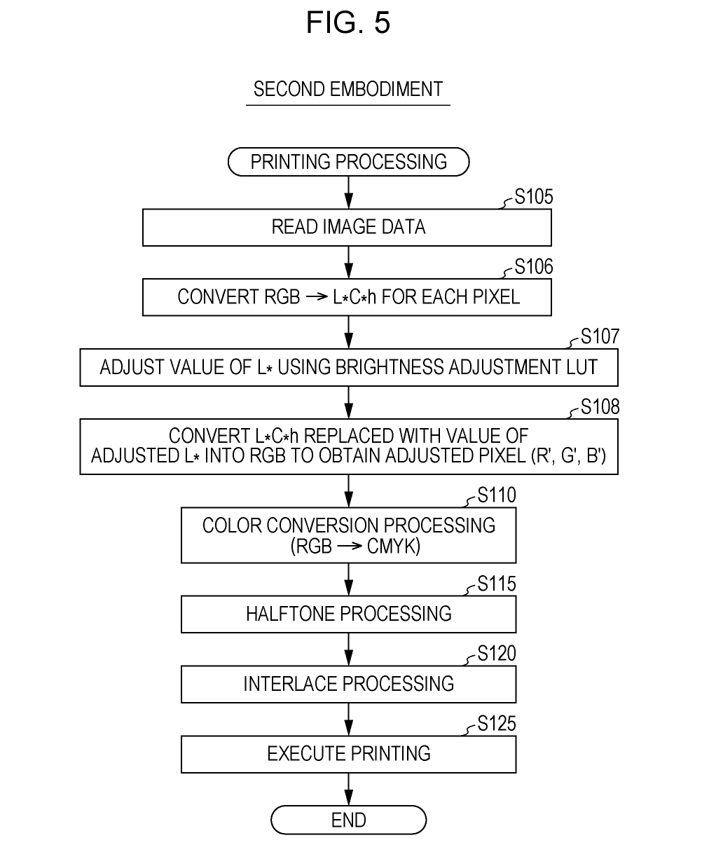

FIG. 5 is an explanatory diagram showing a procedure of printing processing according to the second embodiment. The printer of the second embodiment is different from the printer 20 shown in FIG. 1 in that Steps S106 to S108 are additionally executed in the printing processing and that the LUT 62 is an existing LUT, and the other configurations are the same as those in the first embodiment.

According to the printer 20 of the first embodiment, the gradation reproducibility by the color ink is enhanced by performing the color conversion with the use of the LUT 62 set such that the differences in brightness of the ink colors per one gradation level of the input pixel belonging to the highlighted part Ah is greater than the differences in the brightness of the ink colors per one gradation level of the input pixel which does not belong to the highlighted part Ah. On the other hand, the gradation reproducibility by the color ink is enhanced by adjusting the input image (R, G, B) in the printing processing according to the printer of the second embodiment.

Specifically, the color conversion unit 43 converts R, G, B of each pixel read in Step S105 into L* (brightness), C* (saturation), and h (hue angle) after the aforementioned processing in Step S105 in the printing processing shown in FIG. 5 (Step S106). The color space conversion can be performed by a known method.

The color conversion unit 43 adjusts the L* value of each pixel with the use of the brightness adjustment LUT 63 (Step S107). This processing is the same processing in Step S215 in the LUT creating processing according to the first embodiment. Therefore, the pixels belonging to the highlighted part Ah (pixels which satisfy 80≦L*≦100) are adjusted such that the differences in L* between pixels become greater.

The color conversion unit 43 replaces L* from among the values of L*C*h of the pixel obtained in Step S106 with L* adjusted in Step S107, converts the replaced L*C*h into RGB, and obtains the adjusted pixel (R′, G′, B′) (Step S108). This processing is the same processing in Step S220 in the LUT creating processing according to the first embodiment.

As describe above, the same processing in Steps S110 to S125 according to the first embodiment is executed as the processing after obtaining the adjusted pixel (R′, G′, B′). That is, the processing of converting the adjusted pixel (R′, G′, B′) into C, M, Y, K, the halftone processing, and the interlace processing are executed in this order, and the printing is then executed.

According to the printer of the second embodiment with the above configuration, the image data ORG is adjusted such that differences in the brightness between the pixels with different brightness, which belong to the highlighted part Ah, from among the pixels constituting the input image become greater than those between the pixels which do not belong to the highlighted part Ah, and the color conversion processing is then performed. Accordingly, it is possible to perform the color conversion such that the differences in brightness of the ink colors between the pixels with different brightness, which belong to the highlighted part Ah as compared with the pixels which do not belong to the highlighted part Ah in Step S110 (color conversion processing). Therefore, it is possible to enhance the gradation reproducibility by the color ink in the highlighted region in the printed image. In addition, since it is possible to use an existing LUT of the printer 20 as the LUT for the color conversion processing, it is possible to easily update the LUT when the LUT is updated. In other words, it is possible to update the LUT 62 without any complicated operations by storing the updated LUT, which has been manufactured by a manufacture of the printer 20, as it is on the printer 20 (EEPROM 60).

### C. Third Embodiment

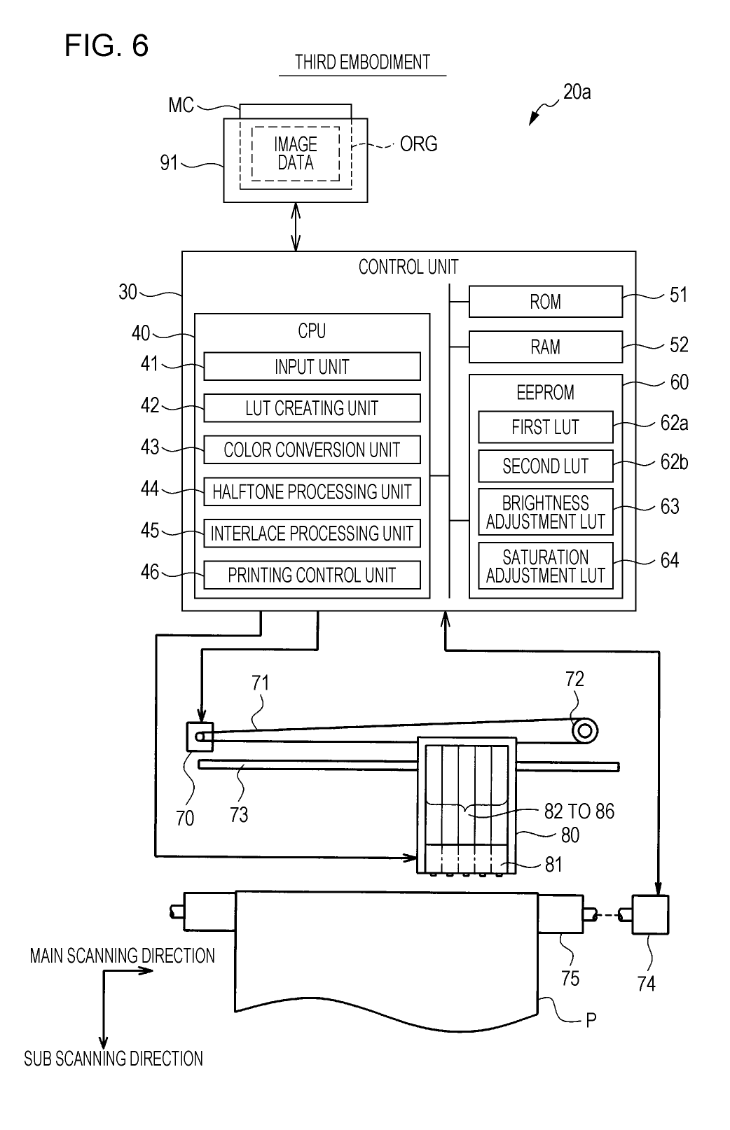

FIG. 6 is a configuration diagram schematically showing a printer according to the third embodiment. The printer 20a of the third embodiment is different from the printer 20 shown in FIG. 1 in that a first LUT 62a and a second LUT 62b are provided instead of the LUT 62, a saturation adjustment LUT 64 is additionally provided, and saturation is also adjusted (emphasized) as well as brightness in the highlighted region of the image, and the other configurations are the same as those in the first embodiment.

Both the first LUT 62a and the second LUT 62b are look up tables used in the color conversion in the printing processing. The first LUT 62a is the look up table in which the same contents as those in the LUT 62 according to the first embodiment are set. Accordingly, the first LUT 62a can be obtained in the LUT creating processing shown in FIG. 3 in the same manner as in the first embodiment. However, the first LUT 62a is used for the color conversion of the pixels which do not belong to the highlighted part Ah in the image unlike in the first embodiment, as will be described later. The second LUT 62b is used for the color conversion of the pixels which belong to the highlighted part Ah in the image. In addition, the details of the second LUT 62b will be described later.

### C1. Second LUT Creating Processing

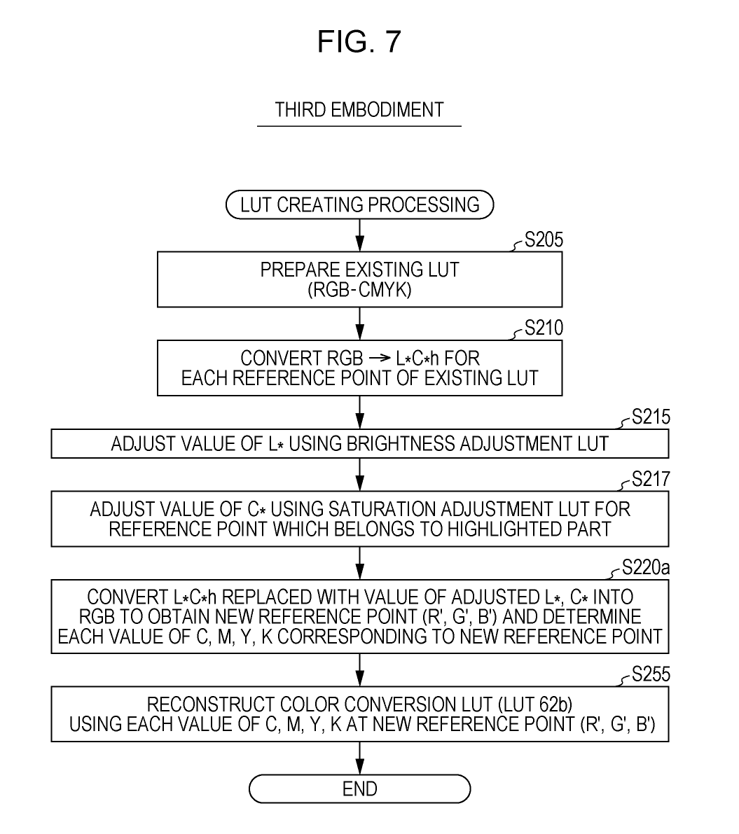

FIG. 7 is a flowchart showing a procedure of the second LUT creating processing according to the third embodiment. The LUT creating processing according to the third embodiment is different from the LUT creating processing according to the first embodiment shown in FIG. 3 in that Step S217 is additionally executed and Step S220a is executed instead of Step S220, and the other processing is the same as that in the first embodiment.

After the execution of the aforementioned Step S205 to S215, the LUT creating unit 42 adjusts the value of C* (saturation) of the reference point belonging to the highlighted part Ah (pixel whose L* value before the adjustment in Step S215 satisfies 80≦L*≦100) with the use of a saturation adjustment LUT 64 shown in FIG. 6 (Step S217).

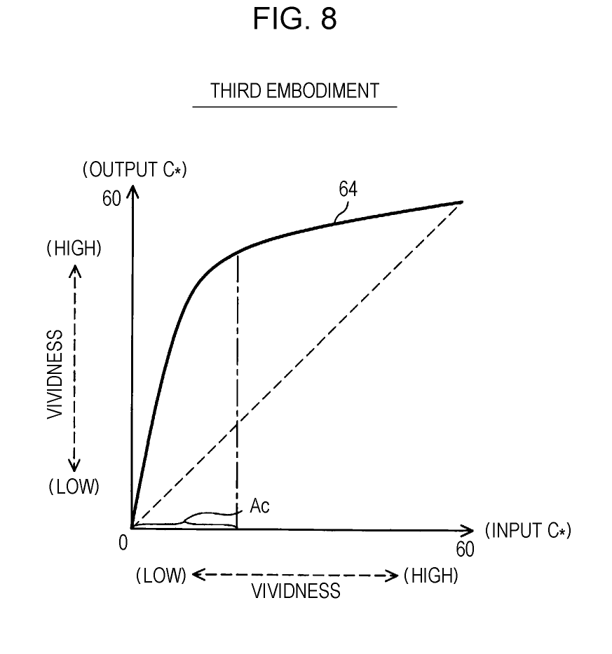

FIG. 8 is an explanatory diagram showing contents of setting of a saturation adjustment LUT shown in FIG. 6. In FIG. 8, the horizontal axis represents the input C* while the vertical axis represents the output value C*. In FIG. 8, a thick solid line schematically shows the saturation adjustment LUT 64. The saturation adjustment LUT 64 is a LUT for converting the input C* value into the output C* value.

As shown in FIG. 8, in the saturation adjustment LUT 64, the increasing degree of the output C* value with respect to the increase in the input C* value in the low saturation part Ac (0≦C*≦20) is set to be greater than the increasing degree of the output C* with respect to the input C* value in the region other than the low saturation part Ac. In addition, the increasing degree of the output C* value with respect to the increase in the input C* value in the low saturation part Ac is set to be greater than the increasing degree of the output C* value with respect to the input C* value before the saturation adjustment (equal to the inclination of the straight line shown by a broken line, increase degree of the output C* with respect to the increase in the input C* value in the first LUT 62a).

Next, the LUT creating unit 42 replaces L* and C* among the values of L*C*h at each reference point obtained in Step S210 with L* adjusted in Step S215 and C* adjusted in Step S217 and converts L*C*h after the replacement into RGB to obtain a new adjusted reference point (R′, G′, B′). In addition, the LUT creating unit 42 determines the values (amounts of ink) of C, M, Y, K corresponding to the new reference point (R′, G′, B′) (Step S220a). The same processing as that in the first embodiment is performed for brightness. Therefore, a new reference point is determined such that the differences in brightness per one gradation level at a reference point belonging to the highlighted part Ah becomes larger. As for saturation, a new reference point is determined such that the differences in saturation per one gradation level at a reference point belonging to the highlighted part Ah and the low saturation part Ac (that is, a reference point whose L* value satisfies 80≦L*≦100 and C* value satisfies 0≦C*≦20) becomes greater. Here, a reference point which belongs to both the highlighted part Ah and the low saturation part Ac means a reference point corresponding to a color which is relatively bright and faint. In addition, the mounts of ink C, M, Y, K corresponding to the new reference point can be obtained by the interpolating computation on the basis of the amounts of ink at each reference point in the existing LUT, for example.

After obtaining a new reference point (R′, G′, B′), the aforementioned Step S225 is executed to generate the second LUT 62b. In the thus obtained second LUT 62b, the differences in the brightness of ink colors per one gradation level at reference points belonging to the RGB color space region corresponding to the highlighted part Ah are greater than those at the reference points belonging to the region other than the RGB color space in the same manner as in the first LUT 62a. In addition, the differences in saturation of the ink color per one gradation level at reference points belonging to the RGB color space region corresponding to the low saturation part Ac are greater than those at the reference points belonging to the region other than the RGB color space.

### C2. Printing Processing

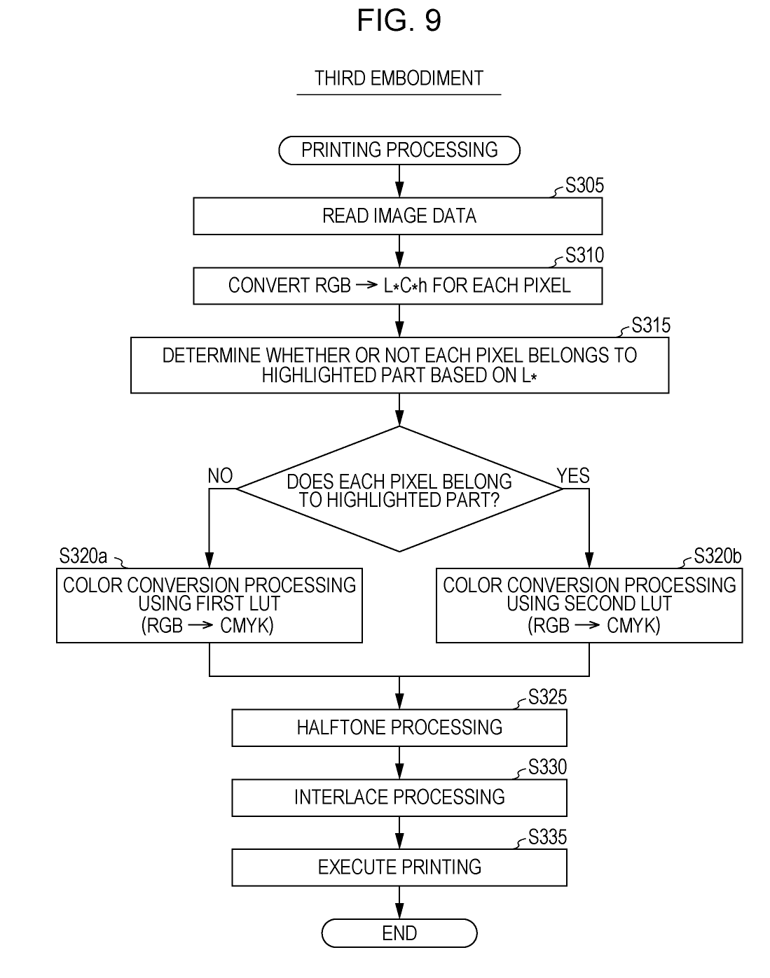

FIG. 9 is a flowchart of the printing processing according to the third embodiment. The processing to be firstly executed in Step S305 is the same processing in Step S105 in the printing processing according to the first embodiment shown in FIG. 2. Next, the color conversion unit 43 converts R, G, B of each pixel read in Step S105 into L*(brightness), C*(saturation), and h(hue angle) (Step S310). Such color space conversion can be performed using a known method.

The color conversion unit 43 determines whether or not each pixel belongs to the highlighted part Ah based on L* (Step S315). It is determined that the pixel whose L* value satisfies 80≦L*≦100 is a pixel belonging to the highlighted part Ah while the pixel whose L* value satisfies L*<80 is a pixel which does not belong to the highlighted part Ah.

The color conversion unit 43 performs the color conversion from R, G, B into C, M, Y, K on the pixels which do not belong to the highlighted part Ah with the use of the first LUT 62a (Step S320a). In addition, the color conversion unit 43 performs the color conversion from R, G, B into C, M, Y, K on the pixels belonging to the highlighted part Ah with the use of the second LUT 62b (Step S320b).

It is possible to avoid generation of significant differences in brightness between the pixels which belong to the highlighted part Ah and the pixels which do not belong to the highlighted part Ah, by performing the color conversion on the pixels which do not belong to the highlighted part Ah not with the use of the existing LUT but with the use of the first LUT 62a in which the differences in brightness per one gradation level in the highlighted part Ah are set to be large.

After the color conversion (Step S320a, S320b), the halftone processing (Step S325) and the interlace processing (Step S330) are executed in this order, and printing is then executed (Step S335). Step S325 to S335 are the same as the aforementioned Step S115 to S125 shown in FIG. 2.

In the aforementioned Step S320b, the color conversion is performed on the pixels belonging to the highlighted part Ah with the use of the second LUT 62b. Therefore, the increasing degree of C* of the color obtained in the actual printing with respect to the increase in the C* value of the input pixel belonging to the low saturation part Ac in the highlighted part Ah becomes greater than that of the pixels which do not belong to the low saturation part Ac. Accordingly, the brightness and the vividness per one gradation level are increased in the bright region regions with a faint color in the printed image as compared with the other regions. For this reason, the gradation reproducibility in the region with the faint color in the highlighted region of the printed image is enhanced.

The printer 20a according to the third embodiment as described above has the same effects as those by the printer 20 according to the first embodiment. In addition, the printer 20a uses as the LUT to be used in the color conversion for the pixels belonging to the low saturation part Ac the second LUT 62b set such that the differences in saturation of the ink color per one gradation level of the input pixels belonging to the low saturation part Ac become larger than those in saturation of the ink color per one gradation level of the input pixels which do not belong to the low saturation part Ac. The input pixels belonging to the low saturation part Ac are pixels for expressing relatively bright image regions with a faint color. Since the pixels with faint colors have low vividness, it is difficult to recognize the change in gradation. Therefore, it is possible to enhance the gradation reproducibility in the highlighted region of the printed image since the printer 20a of the third embodiment can perform printing such that the differences in saturation of the ink colors per one gradation level of pixels for which it is difficult to recognize the change in gradation become great. Accordingly, it is possible to further suppress the lowering of the gradation reproducibility in the highlighted region of the printed image even when the printing is performed with the use of the metallic ink S in addition to the color ink.

The color conversion unit 43, the first LUT 62a, and the second LUT 62b in the third embodiment correspond to the color conversion unit in the appended claims.

### D. Fourth Embodiment

The printer according to the fourth embodiment is different from the printer 20 according to the first embodiment shown in FIG. 1 in that the metallic ink amount Sv is reduced in a shadow region in which a brightness index value is equal to or less than a predetermined value in the image, and the other configurations are the same as those in the first embodiment. The metallic ink amount Sv is reduced in the shadow region for the purpose of reducing the running costs for printing by reducing the use amount of the metallic ink S which is relatively expensive and enhancing the color range and the gradation reproducibility in the shadow region.

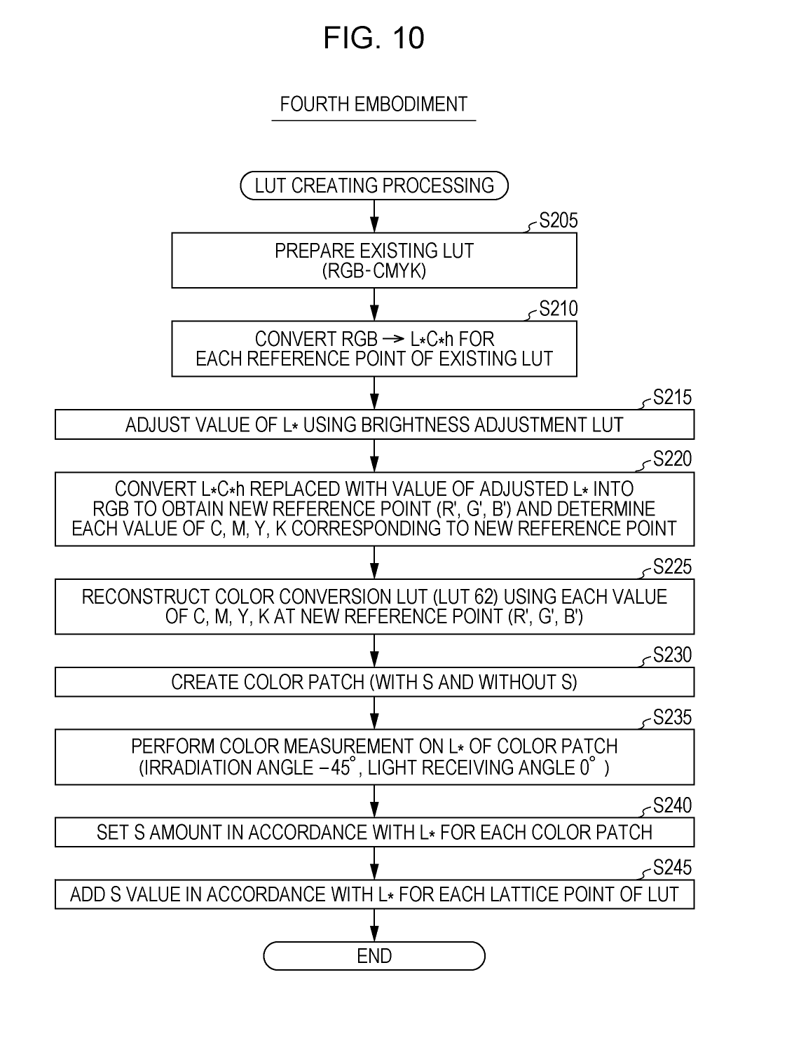

FIG. 10 is a flowchart showing a procedure of the LUT creating processing according to the fourth embodiment. The LUT creating processing according to the fourth embodiment is different from the LUT creating processing according to the first embodiment shown in FIG. 3 in that Step S230 to S245 are additionally executed after Step S225, and the other processing is the same as that in the first embodiment.

When the processing from Step S205 to S225 is executed, and the reconstruction of the LUT 62 is completed, the user creates a color patch in which the metallic ink S is not used and a color patch in which the metallic ink S is used (Step S230). The color patch described here is obtained by performing the color conversion processing on image data with predetermined colors, whose gradation is changed at a predetermined pitch, with the use of reconstructed LUT 62 and printing the image data with a printer. The color patch in which the metallic ink S is not used is a color patch including only a color region and referred to as a single color patch. The color patch in which the metallic ink S is used is a color patch in which the metallic ink S is superimposed on the single color patch at a predetermined duty and also referred to as a superimposed color patch. The superimposed color patch in this embodiment is obtained by superimposing the metallic ink S at the ink duty of 30%. In addition, the ink duty is set to 30% for the same reason that the ink duty of the metallic ink S is set to 30% in the first embodiment.

In this embodiment, the color patch is created by printing the image data with the printer which mounts the LUT 62 as a creation target as described above. This is because the performance of the LUT 62 created by a method which will be described later is enhanced by creating the color patch under a condition that the LUT 62 is used. However, it is not necessary to use the printer for creating the color patch.

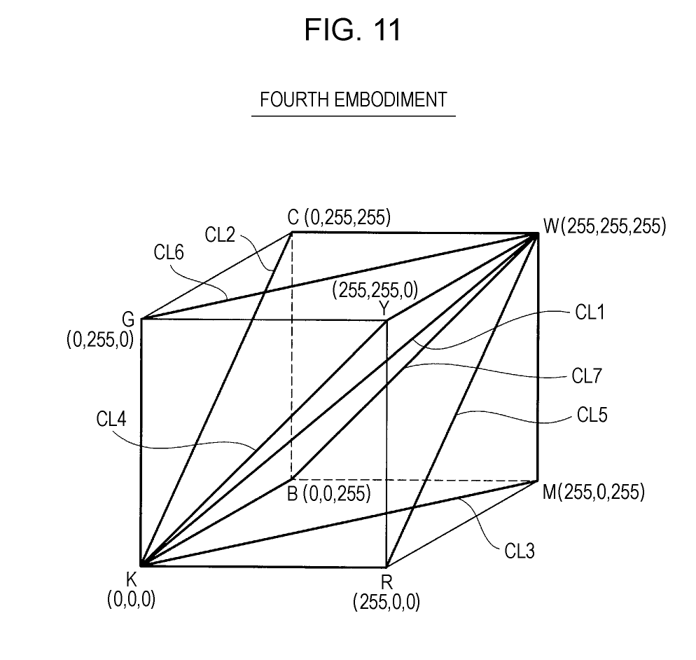

FIG. 11 is an explanatory diagram schematically showing the RGB color space relating to the input value of the printer according to the fourth embodiment. As shown in FIG. 11, the RGB color space (gradation value of 0 to 255) relating to the input value of the printer is specified as an inner space of a cube with eight vertexes K (0, 0, 0), W (255, 255, 255), R (255, 0, 0), G (0, 255, 0), B (0, 0, 255), C (0, 255, 255), M (255, 0, 255), and Y (255, 255, 0).

In this embodiment, the predetermined colors of the color patch is set to the colors with a total of seven hues including: a color line CL1 linearly connecting vertex K and vertex W; a color line CL2 linearly connecting vertex K, vertex C, and vertex W; a color line CL3 linearly connecting vertex K, vertex M, and vertex W; a color line CL4 linearly connecting vertex K, vertex Y, and vertex W; a color line CL5 linearly connecting vertex K, vertex R, and vertex W; a color line CL6 linearly connecting vertex K, vertex G, and vertex W; and a color line CL7 linearly connecting vertex K, vertex B, and vertex W. In addition, the color gradation change pitch in the color patch is set to divide each color line into thirty two levels. In this embodiment, color gradation value 1 is W (255, 255, 255), while the color gradation value 32 is K (0, 0, 0) in any one of the color lines.

When the color patch is created, brightness (L*) of each color gradation in the single color patch and the superimposed color patch is measured with the use of a color measuring instrument (Step S235). In this embodiment, L* is measured with the irradiation angle of −45° and the light receiving angle of 0°. However, the color measurement conditions are not limited to such conditions and may be appropriately set.

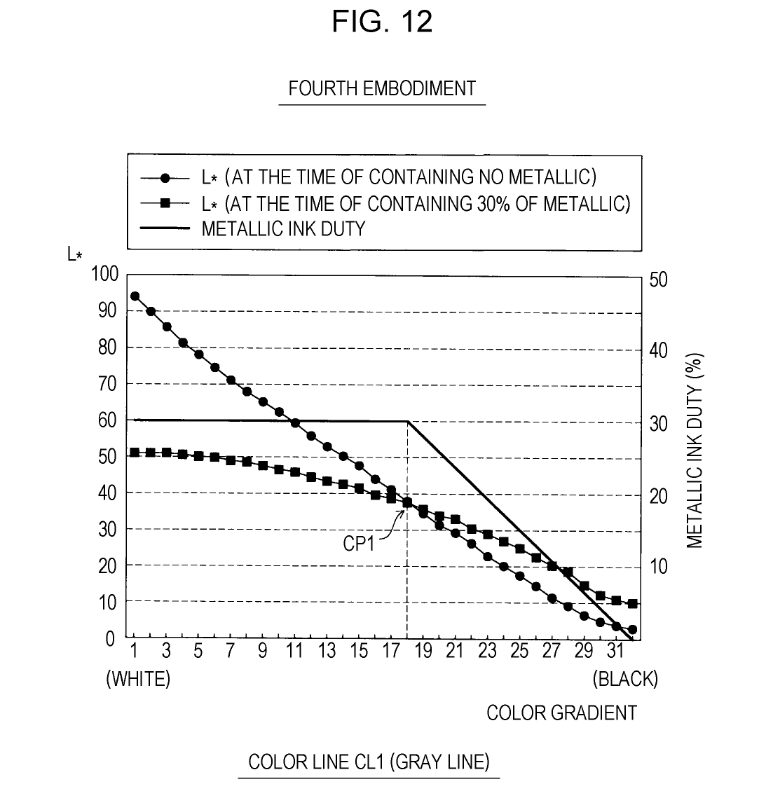

When L* is measured, the use amount (ink duty) of the metallic ink S for each color gradation is then set in accordance with the measured L* (Step S240). The setting method of the use amount of the metallic ink S will be described in detail with reference to FIG. 12. FIG. 12 is an explanatory diagram showing a relationship between each color gradation in the single color patch (“at the time of containing no metallic ink” in the drawing) and the superimposed color patch (“at the time of containing 30% of metallic ink” in the drawing) in the color line CL1 and L* measured in the above Step S235. In addition, the ink duty of the metallic ink S set on the basis of the relationship is shown. As shown in the drawing, it can be understood that the relation line of the single color patch and the relation line of the superimposed color patch intersect with each other at an intersection CP1 (color gradation value 18) in the color line CL1.

In this embodiment, the ink duty of the metallic ink S is set to a constant value of 30% for the color gradation which is closer to white than the intersection CP1, namely the color gradation whose L* is higher than that at the intersection CP1. In addition, the ink duty of the metallic ink S is set to become lower as L* is decreased for the color gradation which is closer to black than the intersection CP1, namely the color gradation whose L* is lower than that at the intersection CP1 (shadow part), and the ink duty of the metallic ink S is set to 0% for black.

If the reduction start point from which the reduction of the ink duty of the metallic ink S is started is set in the color gradation whose L* is higher than that at the intersection CP1, L* becomes higher at the reduction start point although the color gradation approaches black (such a phenomenon is referred to as a brightness inversion phenomenon in this application). In short, it is not possible to realize a smooth change in gradation of L* at the reduction start point since L* becomes lower as the color gradation approaches black for the other color gradation. From such a viewpoint, it is preferable to set the reduction start point in the gradation whose L* is equal to or lower than L* of the intersection CP1. In this embodiment, the reduction start point is set at the intersection CP1.

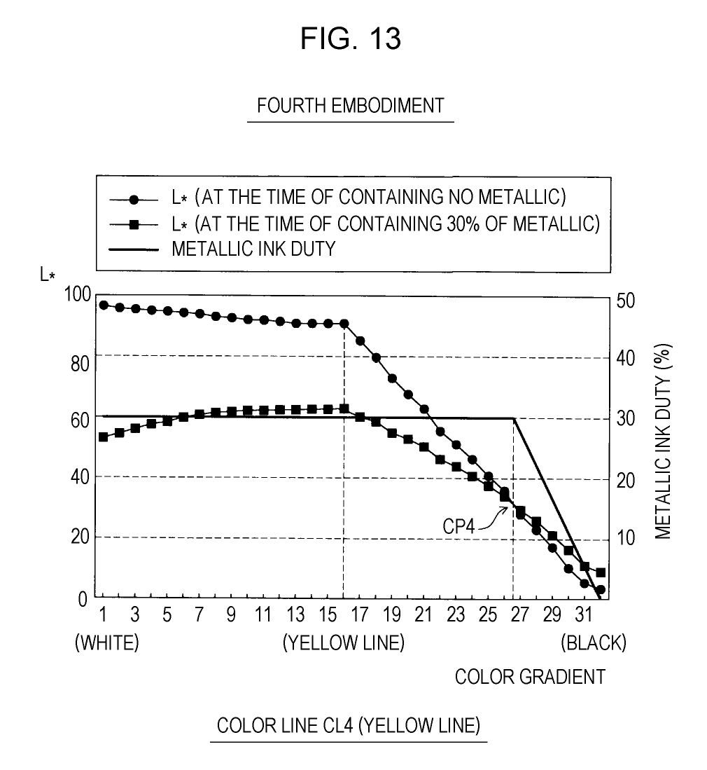

FIG. 13 is an explanatory diagram showing a relationship between each color gradation and L* in the color line CL4. It can be understood that the relation line of the single color patch and the relation line of the superimposed color patch intersect with each other at an intersection CP4 even in the color line CL4 in the same manner as in the color line CL1. Accordingly, the ink duty of the metallic ink S is similarly set to a constant value of 30% for the color whose L* is higher than that at the intersection CP4, and the ink duty of the metallic ink S is set to become lower as L* is decreased for the color whose L* is equal to or less than that at the intersection CP4, and 0% for black. In addition, the amount of the metallic ink S is similarly set for the other color lines although not described herein.

When the amount of the metallic ink S is set as described above, the output value (metallic ink amount Sv) of the metallic ink S is added for each lattice point in the existing LUT based on the amount of the metallic ink S determined in the above Step S240 (Step S245). Specifically, the color gradation values shown as the horizontal axes in FIGS. 12 and 13 correspond to the values of the color gradation change in the color patch. Therefore, the color gradation values are replaced with the gradation values in the existing LUT to obtain the relationship between the gradation values in the existing LUT and the metallic ink S. Then, the metallic ink amount Sv to be added to each lattice point belonging to the color lines CL1 to CL7 based on the obtained relationship. Then, the metallic ink amount Sv of the lattice point which does not belong to the color lines CL1 to CL7 is calculated by interpolating calculation using a lattice point belonging to the color lines CL1 to CL7. The interpolating calculation can be performed using one of various known methods used when the output value between the lattice points (reference points) in the LUT is obtained. The LUT 62 is completed by obtaining and adding the metallic ink amounts Sv for all lattice points as described above. In addition, the metallic ink amount Sv may be set in accordance with the L* value at each lattice point based on the relationship between L* shown in FIGS. 12 and 13 and the ink duty of the metallic ink S by converting the RGB value at each lattice point in the LUT reconstructed in Step S225 into the L*a*b* value.

In this embodiment, the metallic ink amount Sv is determined for the lattice points belonging to the color lines CL1 to CL7 based on the relationship between each color gradation and L*. However, the number of color lines and color hues to be set may be appropriately set. For example, it is matter of course that it is possible to create a more precise LUT if the number of color lines is increased.

The printer with the above configuration according to the fourth embodiment has the same effects as those of the printer 20 according to the first embodiment. In addition, the use amount of the metallic ink S for the pixels belonging to the dark shadow part in which L* is equal to or less than the predetermined value is relatively decreased in the printer of the fourth embodiment. In other words, the use amount of the metallic ink S is reduced in a printed region in which the ink duty of the color ink is high and the metallic sense obtained by the metallic ink S is relatively small. Accordingly, it is possible to effectively reduce the use amount of the metallic ink S. In addition, in a configuration in which the metallic ink S is uniformly superimposed regardless of the ink duty of the color ink, the duty restriction becomes severe and the color reproductive range becomes narrower by an amount of the metallic ink S to be superimposed in the high duty region of the color ink. However, the configuration of this embodiment makes it possible to suppress such a problem and suppress lowering of the printed image quality.

According to the printer of the fourth embodiment, the amount of the metallic ink S for each pixel belonging to the shadow part is reduced as L* is lowered. Therefore, it is possible to realize a smooth change in gradation of L* in the printed region in which the metallic ink S is reduced.

According to the printer of the fourth embodiment, the amount of the metallic ink S is reduced in the printed region, in which L* is equal to or lower than L* at the intersection at which the relation line of the single color patch and the relation line of the superimposed color patch intersect with each other, in the color lines CL1 to CL7. Therefore, the printed image quality is not lowered due to the brightness inversion phenomenon.

### E. Fifth Embodiment

The printer according to the fifth embodiment is different from the printer according to the fourth embodiment in the setting method of the metallic ink amount Sv, and the other configurations are the same as those of the printer in the fourth embodiment.

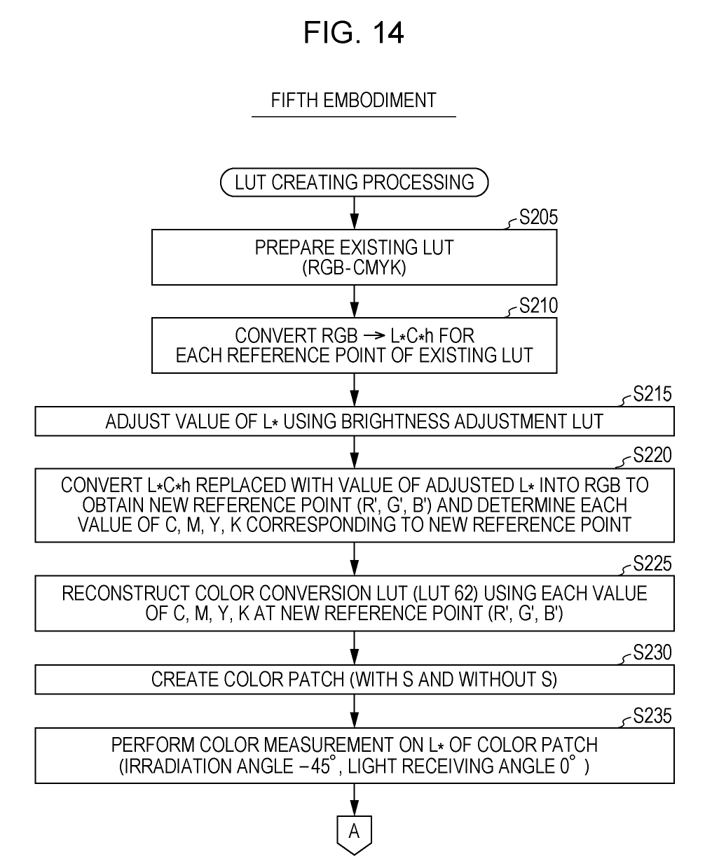

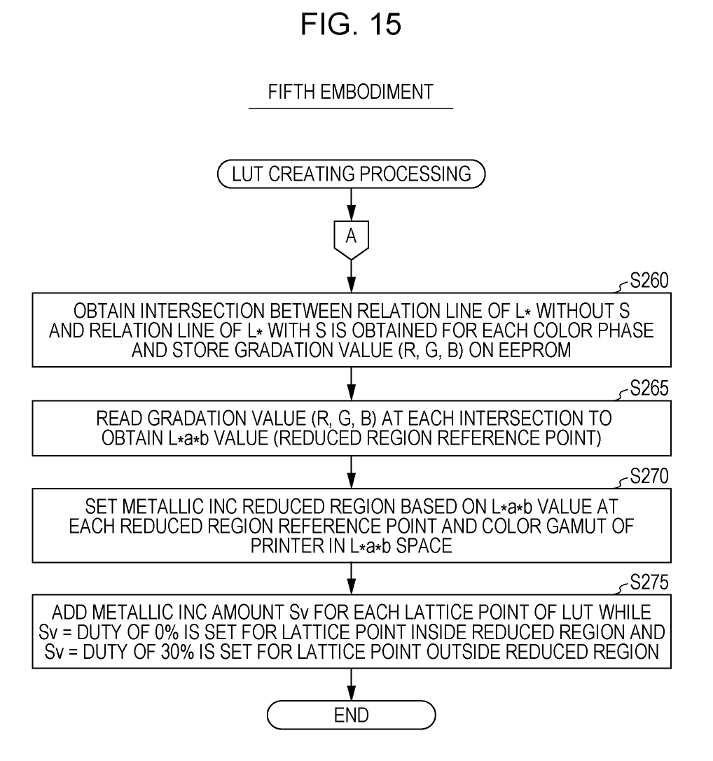

FIG. 14 is a first flowchart showing a procedure of the LUT creating processing according to the fifth embodiment. FIG. 15 is a second flowchart showing a procedure of the LUT creating processing according to the fifth embodiment. The processing from Step S205 to S235 shown in FIG. 14 is the same as the processing from Step S205 to S235 according to the fourth embodiment shown in FIG. 10.

When the brightness (L*) of each color gradation for each color patch is measured (Step S235), an intersection between the relation line of the gradation obtained by measuring the color in the single color patch and the relation line of the gradation obtained by measuring the color in the superimposed color patch for each hue is obtained as shown in FIG. 15. Then, the EEPROM 60 is made to store the gradation value (R, G, B) at the intersection (Step S260). The “intersection” in Step S260 means the intersection CP1 shown in FIG. 12, the intersection CP4 shown in FIG. 13, or the like.

As shown in FIG. 12, the relation line of the single color patch and the relation line of the superimposed color patch intersect at the intersection CP1 (color gradation value 18) in the color line CL1. That is, the brightness at the time of containing the metallic ink is higher (brighter) than the brightness at the time of containing no metallic ink at the same color gradation on the darker side (closer to black) than the color gradation value 18. Therefore, the color reproductive range (the range of L*) at the time of containing the metallic ink is narrower than that at the time of containing no metallic ink on the darker side (closer to black) than the intersection point CP1. On the other hand, the brightness at the time of containing the metallic ink is lower (darker) than the brightness at the time of containing no metallic ink at the same color gradation on the brighter side (closer to white) than the color gradation value 18.

As shown in FIG. 13, the relation line of the single color patch and the relation line of the superimposed color patch intersect at the intersection CP4 (color gradation value 26) in the color line CL4. That is, the brightness at the time of containing the metallic ink is higher (brighter) than the brightness at the time of containing no metallic ink at the same color gradation on the darker side (closer to black) than the color gradation value 26. Therefore, the color reproductive range (the range of L*) at the time of containing the metallic ink is narrower than that at the time of containing no metallic ink on the darker side than the intersection point CP4. On the other hand, the brightness at the time of containing the metallic ink is lower (darker) than the brightness at the time of containing no metallic ink at the same color gradation on the brighter side (closer to white) than the color gradation value 26.

As described above, seven intersections CP1 to CP7 are obtained for each hue in Step S260. In addition, the above processing from Step S230 to S260 can be performed by the user. When the gradation values (R, G, B) of the seven intersections CP1 to CP7 obtained in Step S260 are stored on the EEPROM 60, the subsequent processing is executed.

The LUT creating unit 42 reads the gradation values of the seven intersections CP1 to CP7 from the EEPROM 60 and obtains points (hereinafter, referred to as “reduced region reference points”) RP1 to RP7 corresponding to the intersections CP1 to CP7 in the L*a*b* color space (Step S265). As a method of obtaining the reduced region reference points RP1 to RP7, a known method of converting the RGB color space into the L*a*b* color space can be used.

The LUT creating unit 42 sets the metallic ink reduced region based on each of the reduced region reference points RP1 to RP7 obtained in Step S265 and the color gamut of the printer (Step S270). The metallic ink reduced region means a region, in which the amount of the metallic ink is reduced as compared with the other region, in the color reproductive region specified by the color gamut.

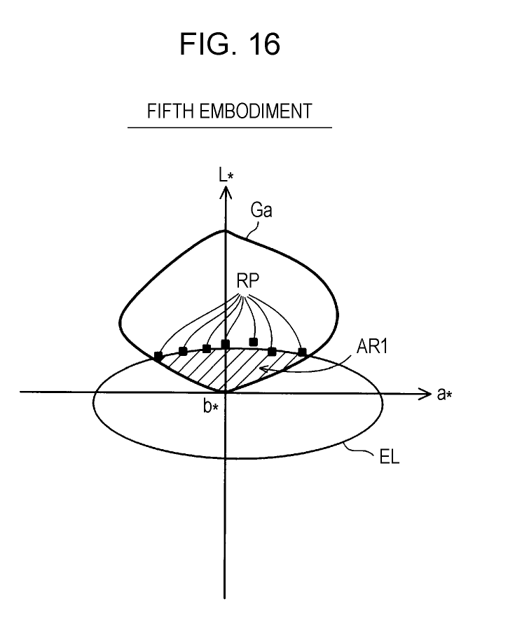

FIG. 16 is an explanatory diagram schematically showing a method of setting the metallic ink reduced region according to the fifth embodiment. In FIG. 16, the horizontal axis represents an a* axis while the vertical axis represents an L* axis. In addition, FIG. 16 shows the L*a*b* space viewed from the b* axis. In FIG. 16, the color gamut Ga represents the color gamut of the printer in the L*a*b* color space. Moreover, the region AR1 represents the metallic ink reduced region AR1 in FIG. 16.

In this embodiment, the metallic ink reduced region AR1 is set as follows. First, an ellipsoidal spherical shape EL with a surface near each of the reduced region reference points RP1 to PR7 is determined in the L*a*b* color space. Then, the overlapped part between the inside of the ellipsoidal spherical shape EL and the color gamut Ga is set to the metallic ink reduced region AR1.

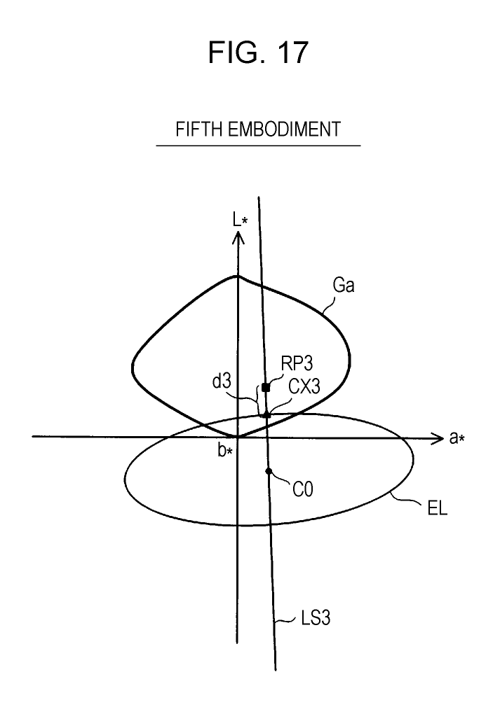

FIG. 17 is an explanatory diagram schematically showing a method of determining the ellipsoidal spherical shape shown in FIG. 16. In FIG. 17, the horizontal axis and the vertical axis are the same as those in FIG. 16. In FIG. 17, a point C0 represents the center point C0 of the ellipsoidal spherical shape EL. In addition, a point RP3 represents one reduced region reference point RP3.

The ellipsoidal spherical shape EL can be determined as follows, for example. First, the ellipsoidal spherical shape EL is determined by a coordinate (L* value, a* value, b* value) of the center point C0, the three radiuses along three special axes, and three rotation angles from each of the L* axis, the a* axis, and the b axis, and straight lines LS1 to LS7 connecting to the center point C0 and each of the reduced region reference points RP1 to RP7 are determined. Then, the intersections CX1 to CX7 between each of the straight lines LS1 to LS7 and the color gamut Ga are obtained, and the distances d1 to d7 between each of the intersections CX1 to CX7 and each of the reduced region reference points RP1 to RP7 is then obtained. Then, each parameter (the coordinate of the center point C0, the three radiuses, the three rotation angles) defining the ellipsoidal spherical shape EL is changed to obtain each of the distances d1 to d7, and each parameter is set by fitting such that the average value (average distance) of distances d1 to d7 is minimized.

In the example of FIG. 17, the straight line LS3 connecting the center point C0 and the reduced region reference point RP3 is determined, and the intersection CX3 between the straight line LS3 and the color gamut Ga is obtained. Then, each parameter defining the ellipsoidal spherical shape EL is determined such that the average distance including distance d3 between the intersection CX3 and the reduced region reference point RP3 is minimized.

When the ellipsoidal spherical shape EL is determined, the LUT creating unit 42 causes the EEPROM 60 to store each parameter of the ellipsoidal spherical shape EL with the profile data of the color gamut Ga and completes the setting of the metallic ink reduced region AR1.

The metallic ink reduced region AR1 is determined based on the reduced region reference points RP1 to RP7 corresponding to the intersections CP1 to CP7 obtained in Step S260 as described above because of the following reason. As shown in FIG. 12, L* at the time of containing no metallic ink is higher (namely, brighter) than L* at the time of containing the metallic ink on the brighter side (the side closer to white) from the intersection CP1 in the color line CL1 as described above. Accordingly, if the metallic ink reduced region AR1 is determined based on the point in the L*a*b* color space corresponding to the point of color gradation whose L* is higher than that at the intersection CP1, there is a concern of the occurrence of the brightness inversion phenomenon described in the fourth embodiment occurs and the smooth change in gradation of L*(brightness) cannot be expressed. In addition, when the metallic ink reduced region AR1 is determined based on the point in the L*a*b* color space corresponding to the point of the color gradation whose L* is lower than that at the intersection CP1, the reproductive color range becomes narrower as compared with the case where the metallic ink reduced region AR1 is determined based on the reduced region reference point RP1 corresponding to the intersection CP1.

As described above, the metallic ink reduced region AR1 is set with the use of the ellipsoidal spherical shape EL as described above since it is possible to avoid that the border (brightness) at which the metallic ink amount is reduced is extremely different between adjacent hues, for example, because the inclination (degree of change) at the surface is smooth and there is no part which suddenly changes. In addition, the number of parameters to be used for fitting is nine (the coordinate of the center point C0, the three radiuses, and the three rotation angles) and relatively large in the ellipsoidal spherical shape EL. Therefore, it is possible to determine the metallic ink reduced region with the surface near each of the reduced region reference points RP1 to RP7.

When the setting of the metallic ink reduced region is completed (Step S270), the LUT creating unit 42 determines whether or not each lattice point in the LUT (the LUT reconstructed in Step S225) is included in the metallic ink reduced region AR1 set in Step S270. The ink duty of 30% is set as the metallic ink amount Sv for the lattice point which is not included in the metallic ink reduced region AR1. The ink duty of 0% is set as the metallic ink amount Sv for the lattice point included in the metallic ink reduced region AR1. Each of set metallic ink amounts Sv is added to each lattice point in the LUT (Step S275).

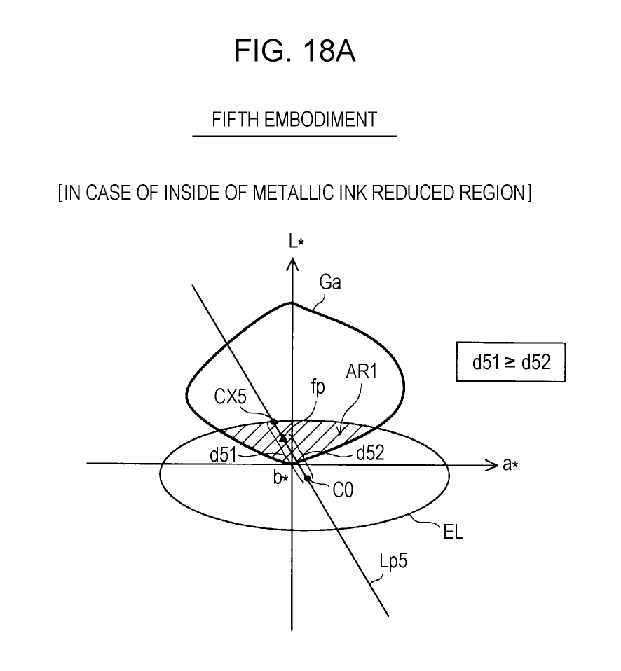

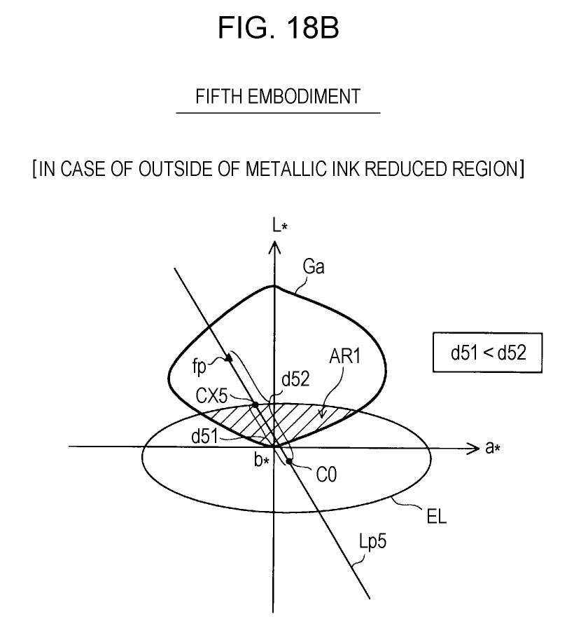

FIGS. 18A and 18B are explanatory diagrams schematically showing a method of determining whether or not the lattice point in the LUT is included in the metallic ink reduced region. FIG. 18A shows a case where the lattice point is included in the metallic ink reduced region AR1. FIG. 18B shows a case where the lattice point is not included in the metallic ink reduced region AR1. In FIGS. 18A and 18B, the horizontal axis and the vertical axis are the same as those in FIGS. 16 and 17.

As a method of determining whether or not the lattice point in the LUT is included in the metallic ink reduced region, the following method can be employed, for example. First, the lattice point (R, G, B) in the LUT is converted into a coordinate on the L*a*b* color space to determine a lattice point fp (L*, a*, b*) on the L*a*b* color space. Then, a straight line Lp5 connecting the lattice point fp and the center point C0 of the ellipsoidal spherical shape EL is obtained, and the intersection CX5 between the straight line Lp5 and the color gamut Ga is obtained. Then, the distance d51 between the center point C0 and the intersection CX5 and the distance d52 between the center point C0 and the lattice point fp are compared. If the distance d51 is equal to or longer than the distance d52, it is determined that the lattice point fp is included in the metallic ink reduced region AR1 as shown in FIG. 18A. On the other hand, if the distance d51 is shorter than the distance d52, it is determined that the lattice point fp is not included in the metallic ink reduced region AR1 as shown in FIG. 18B.

The ink duty of 30% is set as the metallic ink amount Sv for the lattice point which is not included in the metallic ink reduced region AR1 because it is possible to visually recognize the metallic sense expressed by the metallic ink S to the maximum extent at the ink duty of 30% as described above. The ink duty is not limited thereto.

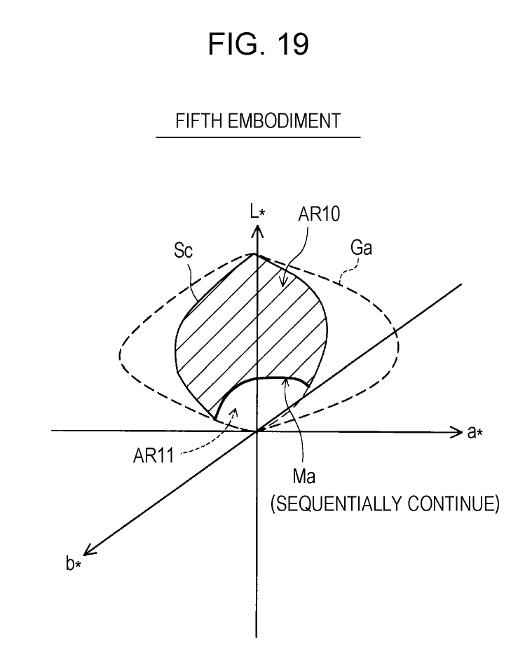

FIG. 19 is an explanatory diagram schematically showing the metallic ink amount observed on the printing medium when an image obtained by the color conversion with the use of the LUT is printed. The printer prints each color included in a certain surface of section Sc including the L* axis is printed in the color gamut Ga. In the example of FIG. 19, the metallic ink amount of each printed color (dot recording rate) is mapped at a position corresponding to each color on the L*a*b* space. As shown in FIG. 19, a region AR10 in which the metallic ink amount is relatively large (the metallic ink amount is not 0) and a region AR11 in which the metallic ink amount is relatively small (the metallic ink amount is 0) appear in the surface of section Sc. In addition, the border Ma between these two regions AR10 and AR11 has a continuously sequential shape.

The printer with the above configurations according to the fifth embodiment has the same effects by the printer according to the first embodiment. In addition, the LUT 62 set such that the metallic ink amount Sv at the lattice point included in the metallic ink reduced region AR1 is smaller than that at the lattice point which is not included in the metallic ink reduced region AR1 is used in the color conversion according to the printer of the fifth embodiment. Here, the metallic ink reduced region AR1 is set on the darker side (the region in which the L* value is relatively small) in the L*a*b* color space. Therefore, it is possible to set the metallic ink amount to be discharged for the pixel included in the metallic ink reduced region AR1 to be smaller than the metallic ink amount to be discharged for the pixel included in the metallic ink reduced region AR1 in the L*a*b* color space, by performing the color conversion with the use of such a LUT 62. Therefore, it is possible to increase the amount of the color ink in the shadow region of the image and thereby to enhance the gradation reproducibility. In addition, the reduced region reference points RP1 to RP7 referred to when the metallic ink reduced region AR1 is determined are determined based on the intersections CP1 to CP7 at which the relation line of the single color patch and the relation line of the superimposed color patch intersect with each other in each of the color lines CL1 to CL7. Therefore, it is possible to suppress the occurrence of the brightness inversion phenomenon.

In addition, since the metallic ink reduced region AR1 is set with the use of the ellipsoidal spherical shape EL, it is possible to smooth the surface of the border in the metallic ink reduced region AR1. Therefore, it is possible to avoid that the border (brightness) at which the metallic ink amount is reduced is extremely different between adjacent hues, for example. In addition, the ellipsoidal spherical shape EL is defined with the use of many parameters. Therefore, it is possible to increase the degree of freedom in the fitting. For this reason, it is possible to set the metallic ink reduced region AR1 with the surface which is much closer to each of the reduced region reference points RP1 to RP7.

In addition, the metallic ink reduced region AR1 is defined in the L*a*b* color space, namely a three-dimensional color space. Therefore, it is possible to relatively determine the metallic ink reduced region AR1. Moreover, the metallic ink reduced region AR1 is set in the L*a*b* color space which is a color space independent from the device. Therefore, it is possible to set the metallic ink reduced region in an appropriate range in the RGB color space of the LUT 62.

In addition, the metallic ink amount Sv is not discharged (the duty is set to 0%) for the pixel corresponding to the lattice point included in the metallic ink reduced region AR1. Therefore, it is possible to significantly suppress the consumption of the metallic ink amount and thereby to greatly reduce the running costs for printing.

### F. Sixth Embodiment

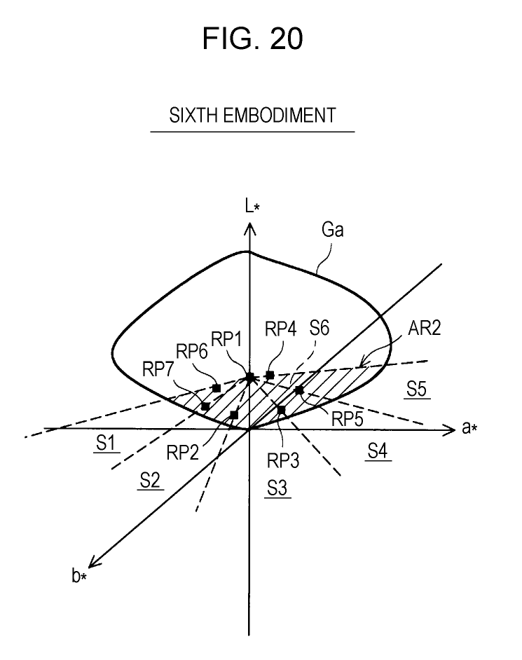

FIG. 20 is an explanatory diagram schematically showing a method of setting the metallic ink reduced region according to the sixth embodiment. In FIG. 20, the horizontal axis and the vertical axis are the same as those in FIG. 16. In addition, FIG. 20 is different from FIG. 16 in that the L*a*b* color space viewed from a viewpoint deviated from the b* axis is shown. The printer according to the sixth embodiment is different from the printer according to the fifth embodiment in the method of setting the metallic ink reduced region, and the other configurations are the same as those in the fifth embodiment. In FIG. 20, the reduced region reference points RP1 to RP7 are the same as those in the first embodiment.

In the sixth embodiment, the metallic ink reduced region AR2 is set as follows. First, the reduced region reference point RP1 corresponding to the intersection CP1 in the color line CL1 (gray axis) is made to liken to a ferrule of an umbrella to set the reduced region reference point RP1 as a vertex. Then, a plane specified by two reduced region reference points determined in two adjacent hues (color lines) is determined. As a result, six planes are determined, each of which has a triangle shape. Then, an umbrella shape formed with such planes is determined, and an overlapped part between the inside of the umbrella shape and the color gamut Ga is set as the metallic ink reduced region AR2.

In the example of FIG. 20, a plane S1 passing through two reduced region reference points RP6 and RP7 is set while the reduced region reference point RP1 is set to a vertex, and in the L*a*b* color space. Similarly, a plane S2 passing through two reduced region reference points RP7 and RP2 is set while the reduced region reference point RP1 is set to a vertex. A plane S3 passing through two reduced region reference points RP2 and RP3 is set while the reduced region reference point RP1 is set to a vertex. A plane S4 passing through two reduced region reference points RP3 and RP5 is set while the reduced region reference point RP1 is set to a vertex. A plane S5 passing through two reduced region reference points RP5 and RP4 is set while the reduced region reference point RP1 is set to a vertex. A plane S6 passing through two reduced region reference points RP4 and RP 6 is set while the reduced region reference point RP1 is set to a vertex, in the L*a*b* color space. Adjacent two planes in the planes S1 to S6 are in contact with each other. In the example of FIG. 20, the overlapped part between the inside of the umbrella shape and the color gamut Ga formed by the planes S1 to S6 is set to the metallic ink reduced region AR2.

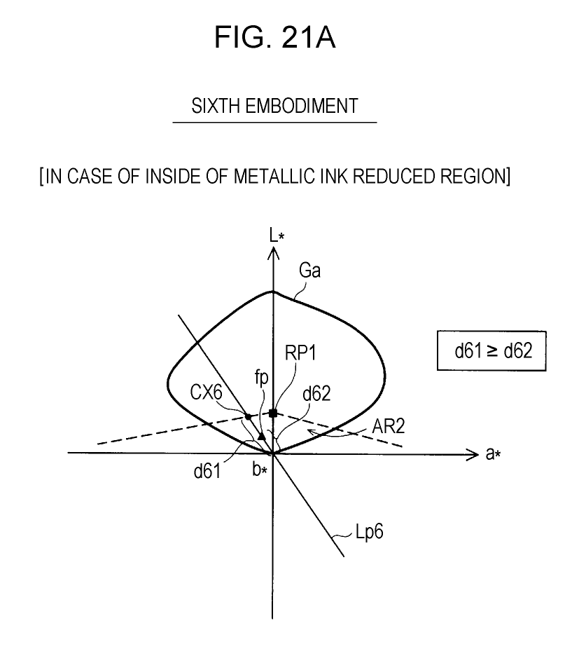

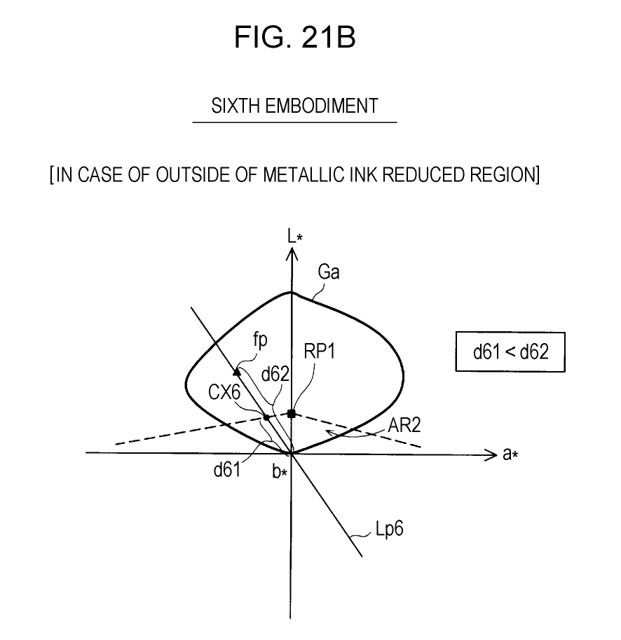

FIGS. 21A and 21B are explanatory diagrams schematically showing whether or not the lattice point in the LUT according to the sixth embodiment is included in the metallic ink reduced region. FIG. 21A shows a case where the lattice point is included in the metallic ink reduced region AR2 while FIG. 21B shows a case where the lattice point is not included in the metallic ink reduced region AR2. In FIGS. 21A and 21B, the horizontal axes and the vertical axes are the same as those in FIGS. 18A and 18B.

In the sixth embodiment, as a method of determining whether or not the lattice point in the LUT is included in the metallic ink reduced region, it is possible to employ the following method, for example. First, the lattice point (R, G, B) in the LUT is converted into a coordinate in the L*a*b* color space to determine the lattice point fp (L*, a*, b*) in the L*a*b* color space. A straight line Lp6 connecting the lattice point fp and an origin (0, 0, 0) is obtained, and the intersection CX6 between the straight line Lp6 and the color gamut Ga is then obtained. Then, the distance d61 between the origin and the intersection CX6 and the distance d62 between the origin and the lattice point fp are compared with each other. If the distance d61 is equal to or longer than the distance d62, it is determined that the lattice point fp is included in the metallic ink reduced region AR2 as shown in FIG. 21A. On the other hand, when the distance d61 is shorter than the distance d62, it is determined that the lattice point fp is not included in the metallic ink reduced region AR2 as shown in FIG. 21B.

The printer with the above configuration according to the sixth embodiment has the same effects as those by the printer according to the fifth embodiment. In addition, the metallic ink reduced region AR2 includes each of the reduced region reference points RP1 to RP7. Therefore, it is possible to position each of the intersections CP1 to CP7 at the boundary between the duties of the metallic ink amounts Sv of 30% and 0% in each of the color lines CL1 to CL7. Accordingly, it is possible to suppress the occurrence of the brightness inversion phenomenon in at least each of the color lines at a higher rate.

### G. Seventh Embodiment

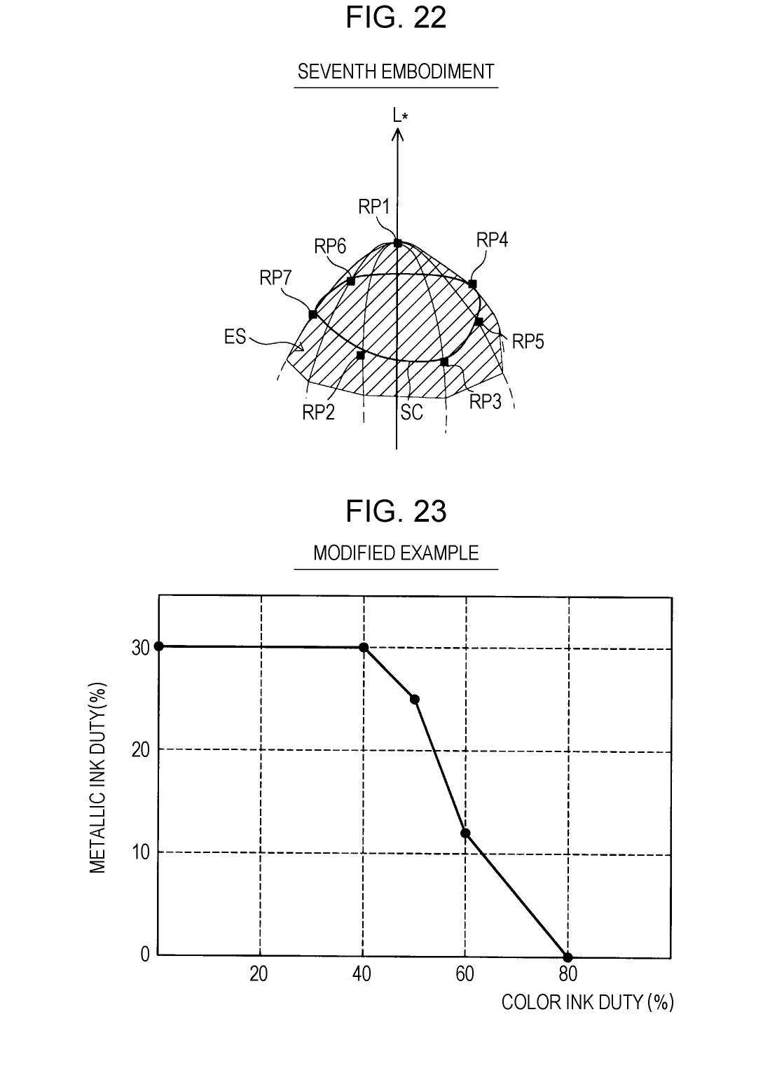

FIG. 22 is an explanatory diagram schematically showing a method of setting the metallic ink reduced region according to the seventh embodiment. In FIG. 22, only the L* axis in the L*a*b* color space is shown for the purpose of convenience. The printer according to the seventh embodiment is different from the printer according to the fifth embodiment in the method of setting the metallic ink reduced region, and the other configurations are the same as those in the fifth embodiment. In FIG. 22, the reduced region reference points RP1 to RP7 are the same as those according to the first embodiment shown in FIG. 16.

In the seventh embodiment, the metallic ink reduced region is set as follows. First, coordinates of six reduced region reference points RP2 to RP6 other than the reduced region reference point RP1 are used to obtain a ring-shaped periodic spline curve SC near each of the reduced region reference points RP2 to RP6. Such a periodic spline curve SC can be calculated with the use of a known spline function. Then, a shape ES as a group of quadratic curves which pass through an arbitrary point on the periodic spline curve SC and through the reduced region reference point RP1 as the vertex is determined, and the overlapped part between the inside of the shape ES and the color gamut Ga is set as a metallic ink reduced region. In FIG. 22, the color gamut Ga and the metallic ink reduced region are omitted.

As a method of setting the metallic ink reduced region, it is also possible to set the metallic ink reduced region by another method, in which a shape as a group of the quadratic curves passing through the reduced region reference point RP1 as a vertex and passing through two arbitrary reduced region reference points is determined and the overlapped part between the inside of such a shape and the color gamut Ga is set to the metallic ink reduced region, for example, instead of the aforementioned method. In other words, an overlapped part between the color gamut Ga and the inside of a shape specified by a quadratic curve passing through the reduced region reference point RP1 and another arbitrary reduced region reference point (first reduced region reference point) and a quadratic curve passing through the reduced region reference point RP1, the first reduced region reference point, and another arbitrary reduced region reference point (second reduced region reference point) is set as the metallic ink reduced region. In addition, the method of determining whether or not the lattice point in the LUT is included in the metallic ink reduced region according to the seventh embodiment is the same as that in the second embodiment. Therefore, the description thereof will be omitted.

The printer with the above configurations according to the seventh embodiment has the same effects as those by the printer according to the fifth embodiment.

### H. Modified Example

The components other than the components claimed in the independent claims are additional components from among the components in each of the above embodiments and can be appropriately omitted. In addition, the invention is not limited to the above embodiments and examples. It is possible to realize the invention in various manners within the scope of the gist. The following modifications can also be made, for example.

### H1. Modified Example 1

In the third embodiment, both the brightness and the saturation are adjusted (emphasized) in the highlighted region. However, another configuration is also applicable in which only saturation is adjusted (emphasized). In such a case, Step S215 as the LUT creating processing shown in FIG. 7 is omitted. Even with such a configuration, it is possible to suppress lowering of the gradation reproducibility in a region with a faint color in the highlighted region. According to this configuration, it is also possible to perform the color conversion processing with the use of the existing LUT instead of the first LUT 62a for the pixels which do not belong to the highlighted region. In the second embodiment, it is possible to employ a configuration in which both the brightness and the saturation or only the saturation is adjusted instead of the configuration in which only the brightness is adjusted.

In the first embodiment, the LUT 62 is used for all pixels as the LUT used in the color conversion processing. However, the invention is not limited thereto. For example, it is possible to employ another configuration in which the color conversion is performed with the use of the LUT 62 for the pixels belonging to the highlighted part Ah while the color conversion processing is performed with the use of the existing LUT for the pixels which do not belong to the highlighted region. Even with such a configuration, it is possible to suppress lowering of the gradation reproducibility in the highlighted region of the image.

### H2. Modified Example 2

In each embodiment, the image data ORG (R, G, B) is converted into L*C*h, and L* (brightness) or C* (saturation) is obtained in order to adjust the brightness or the saturation. However, the invention is not limited thereto. It is possible to obtain B (brightness) or S (saturation) by converting the image data not into L*C*h but into HSB (H: hue, S: saturation, B: brightness). Even with such a configuration, it is possible to obtain a new lattice point by adjusting the B value or the S value and then converting H, S, B into R, G, B. Since only the brightness is adjusted in the first embodiment, it is also possible to adjust L* (brightness) by converting R, G, B not into L*C*h but into L*a*b*.

### H3. Modified Example 3

In each embodiment, the color conversion LUTs (the LUT 62, the first LUT 62a and the second LUT 62b in the third embodiment) are so-called 3D LUTs which converts R, G, B into C, M, Y, K. However, the invention is not limited thereto. It is also possible to employ a multidimensional LUT of 4D or greater. For example, it is also possible to employ a 4D LUT which converts C, M, Y, K into C, M, Y, K. When such a 4D LUT is employed, C, M, Y, K is converted into L*C*h in Step S210 of the LUT creating processing, and L*C*h is converted into C, M, Y, K in Step S220. In addition, a known color conversion method between C, M, Y, K and L*C*h can be employed. In Step S106 in the printing processing according to the second embodiment, C, M, Y, K is converted into L*C*h, and L*C*h is then converted into C, M, Y, K in Step S108.

When the 4D LUT which converts C, M, Y, K into C, M, Y, K is employed, for example, it is also possible to convert C, M, Y, K into R, G, B and further convert R, G, B into H, S, B (or L*C*h) in Step S210 in the LUT creating processing. In addition, it is also possible to convert H, S, B (or L*C*h) into R, G, B and further convert R, G, B into C, M, Y, K in Step S220. Similarly, it is also possible to convert C, M, Y, K into R, G, B, further convert R, G, B into H, S, B (or L*C*h) in Step S106 in the printing processing, and convert H, S, B (or L*C*h) into R, G, B and further convert R, G, B into C, M, Y, K in Step S108 in the second embodiment.

According to the fifth to seventh embodiments, the metallic ink reduced region is determined in the L*a*b* color space, namely a three-dimensional color space, and such a metallic ink reduced region is reflected in the LUT. Therefore, it is possible to easily set the lattice point, at which the metallic ink is reduced, in the LUT since the metallic ink reduced region is determined in the L*a*b* space as a three-dimensional space in which it is relatively easy to define the region, even if the LUT to be created is a multidimensional LUT of 4D or greater.

### H4. Modified Example 4

In each embodiment, the brightness adjustment LUT 63 including setting contents shown in FIG. 4 is used for the adjustment of the brightness (L*). In the third embodiment, the saturation adjustment LUT 64 including the setting contents shown in FIG. 8 is used for the adjustment of the saturation (C*). However, the invention is not limited thereto. For example, it is also possible to employ a configuration in which a relational expression representing the curve in FIG. 4 and a relational expression shown in FIG. 8 are obtained in advance and the adjusted brightness (L*) and the adjusted saturation (C*) are determined and adjusted with the use of such relational expressions.

### H5. Modified Example 5

In each embodiment, the highlighted part Ah is a region in which L* satisfies 80≦L*≦100. However, the invention is not limited thereto. It is possible to employ an arbitrary range in which L* satisfies 50≦L*≦100 as the highlighted part Ah. In the third embodiment, the low saturation part Ac is a region in which C* satisfies 0≦C*≦20. However, the invention is not limited thereto. It is possible to employ an arbitrary range in which C* satisfies 0≦C*≦30 as the low saturation part Ac.

### H6. Modified Example 6

The fourth to seventh embodiments shows a configuration in which the metallic ink amount Sv is reduced when the brightness (L*) of a color expressed by the color ink is equal to or less than the predetermined value. However, an index for reducing the metallic ink amount Sv is not limited to the brightness, and it is possible to use various indexes relating to the brightness of the color expressed by the color ink. For example, luminance, an ink duty, and the like may be used.

### H7. Modified Example 7

In the fourth to seventh embodiment, the reduction point of the metallic ink S is determined by measuring the color in the color patch. However, it is not necessary to measure the color, and the color measurement may be omitted. However, it is matter of course that it is more preferable to perform the color measurement to determine the reduction point of the metallic ink S as in the embodiments since it is possible to reliably suppress the brightness inversion phenomenon.

### H8. Modified Example 8

In the fourth embodiment, the printer is configured to determine the metallic ink amount Sv in the printing processing based on the LUT 62. However, it is not necessary to use the LUT 62. FIG. 23 is an explanatory diagram showing contents of setting for the table to be used for determining the amount of metallic ink in the modified example 1. In FIG. 23, the horizontal axis represents the ink duty (%) of the color ink while the vertical axis represents the ink duty (%) of the metallic ink S. In the table (thick solid line) in FIG. 23, the ink duty of the color ink and the ink duty of the metallic ink S are associated.

For example, the amount of the metallic ink S may be determined based on the ink duty of the color ink by causing the EEPROM 60 to store the table shown in FIG. 23 in advance and referring to this table. In the table shown in FIG. 23, a relatively low ink duty of the metallic ink S is associated with a relatively high color ink duty corresponding to the shadow region in the image. Accordingly, it is possible to relatively reduce the metallic ink amount Sv in the shadow region in the same manner as in the fourth embodiment. In the range of the relatively high color ink duty corresponding to the shadow region in the image, the ink duty of the metallic ink S is lowered as the ink duty of the color ink is increased. Therefore, it is possible to smooth the change in gradation of L* in the printed region in which the metallic ink amount Sv is reduced, in the same manner as in the fourth embodiment.

It is also possible to determine the metallic ink amount Sv in accordance with the various indexes relating to the brightness of the color presented by the input color of the color ink, for example, as well as a configuration in which the table shown in FIG. 23 is used. As such indexes, it is possible to exemplify the L* component in the L*a*b* color space, the Y component in the YCbCr color space, the L* component in the L*u*v* color space, the Y component in the XYZ color space, and the like. With such a configuration, it is possible to reduce the burden of creating the LUT.

### H9. Modified Example 9

In the fourth embodiment, a configuration in which the ink duty of the metallic ink S is set to 30% and the ink duty of the metallic ink S is reduced as L* is decreased from the reduction point of the metallic ink and reaches 0 for black was shown. However, the method of reducing the metallic ink S can be appropriately set in consideration of the printing conditions such as a printing medium and the like, a desired printing quality, the save amount of the metallic ink S and the like. For example, the upper limit of the ink duty may be set to 25% or 35%, or the ink duty may be set to 0 from the point at which L* is higher than black. Alternatively, another configuration is also applicable in which the ink duty reaches not 0 but 10%. It is a matter of course that the invention is not limited to a configuration in which the use amount of the metallic ink S is reduced as L* is lowered and another configuration is also applicable in which a predetermined amount of the metallic ink S is reduced at the reduction point or lower. Even in doing so, it is possible to expect an effect to some extent with a simple configuration.

### H10. Modified Example 10

In the fourth embodiment, the ink duty of the metallic ink S in the case where L* is higher the predetermined value is fixed to the certain value (30%). However, another configuration is also applicable in which the user can select a desired level of the metallic sense required for the printed image quality. In such a case, a configuration is applicable in which the printer stores a plurality of kinds of LUTs (for example, a LUT in which the maximum ink duty is 30% and a LUT in which the maximum ink duty is 15%) and the LUT to be used is switched by the user selection. Alternatively, another configuration is also applicable in which the metallic ink amount Sv obtained by the LUT 62 is multiplied by the predetermined reduction ratio determined in accordance with the user selection to determine the metallic ink amount Sv.

### H11. Modified Example 11

In each embodiment, the printer is an ink-jet printer. However, it is possible to use a laser printer and an offset printing apparatus, which perform printing by causing a gloss and a color toner to adhere onto the printing medium instead of the ink-jet printer. In addition, it is also possible to employ arbitrarily gloss ink instead of the metallic ink. The gloss ink is ink which exhibits gloss on the surface of the printing medium which has been subjected to printing and may be ink, which has an optical property of reflective-angle dependency when the ink is printed on the surface of the printing medium and expresses various appearances depending on the viewing angles, as well as the metallic ink containing pigments expressing the metallic sense. Specifically, it is possible to use pearly luster ink containing pigments which express the sense of pearly luster after the fixation to the surface of the medium, glitter ink or pear skin ink which contain pigments including fine unevenness expressing a so-called sense of glittering or sense of pear skin due to the diffused reflection after the fixation onto the surface of the medium, or the like.

### H12. Modified Example 12

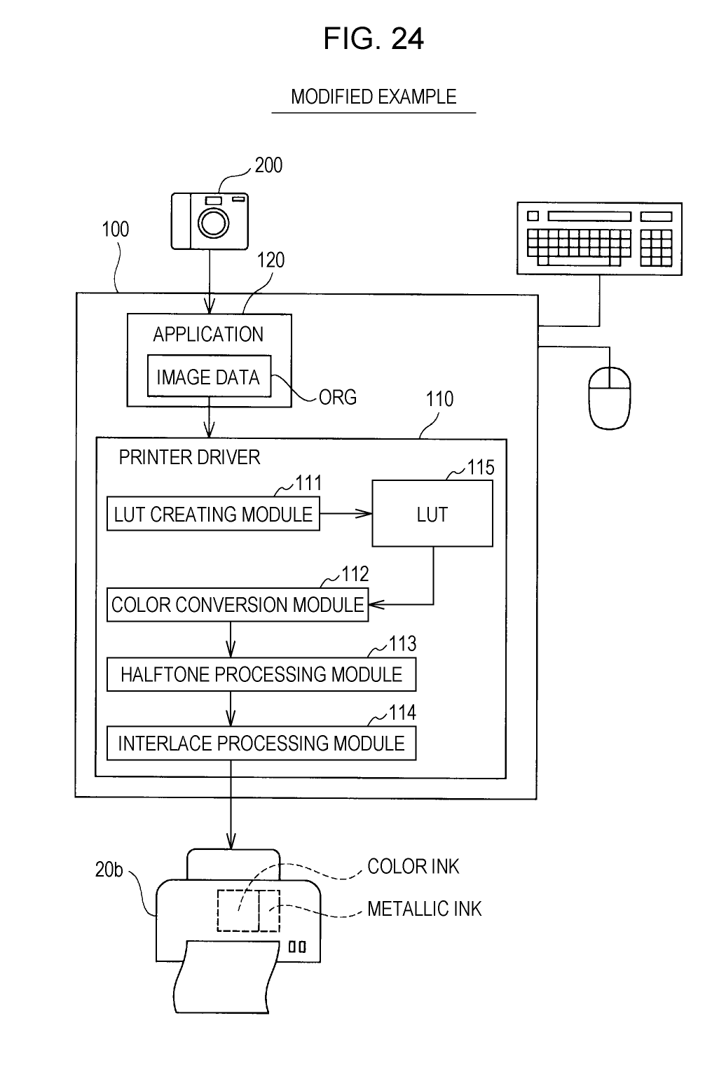

In each embodiment, examples are shown in which the invention is applied to a printer. However, the invention is not limited thereto. For example, the invention can be applied to a computer connected to a printer. FIG. 24 is an explanatory diagram showing an application of the invention to a computer according to the modified example 12.

In FIG. 24, a computer 100 is connected to a printer 20b. In addition, the printer 20b is configured to be printable with the use of the color ink and the metallic ink in the same manner as the printer 20 according to the first embodiment.

A predetermined operating system is installed on the computer 100, and the application program 120 is operated under the operating system. The printer driver 110 is mounted on the operating system. The application program 120 inputs the image data ORG from the digital camera 200 via a circumferential device interface which is not shown in the drawing, for example. Then, the application program 120 outputs the image data ORG to the printer 20b via the printer driver 110. In addition, the image data ORG is the image data in the RGB format in the same manner as the image data ORG in each embodiment.

The printer driver 110 is provided with a LUT creating module 111, a color conversion module 112, a halftone processing module 113, an interlace processing module 114, and a LUT 115.

The LUT creating module 111 has the same functions as those of the LUT creating unit 42 according to the first embodiment shown in FIG. 1. In addition, the color conversion module 112 has the same functions as those of the color conversion unit 43 shown in FIG. 1. The halftone processing module 113 has the same functions as those of the halftone processing unit 44 shown in FIG. 1. The interlace processing module 114 has the same functions as those of the interlace processing unit 45 shown in FIG. 1.

In the computer 100 (printer driver 110) with such configurations, the aforementioned LUT creating processing is executed. Accordingly, the setting contents in the LUT 115 are the same as those in the LUT 62 according to the first embodiment shown in FIG. 1. Therefore, it is possible to achieve the same effects as those by the printer 20 according to the first embodiment, such as the suppression of lowering of the gradation reproducibility in the highlighted region of the printed image, by executing printing by the printer 20b based on the image data after the color conversion with the use of such a LUT 115. In addition, the computer 100 (printer driver 110) in the aforementioned modified embodiment 12 corresponds to the printing apparatus control apparatus in the appended claims. It is also possible to apply the invention not only to the printer and the computer (printer driver) as described above but also to a color conversion method, a color conversion program, a recording medium, a color conversion LUT, a method of creating a color conversion LUT, a printed material, and the like.

### H13. Modified Example 13

In the fifth to seventh embodiments, the metallic ink amount Sv for the lattice point included in the metallic ink reduced region is set to a predetermined value (ink duty=0%). However, the invention is not limited thereto.

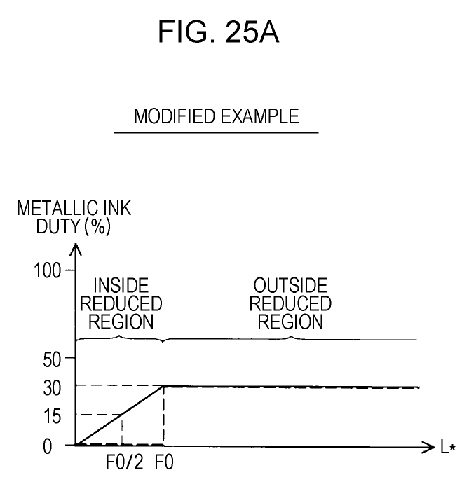

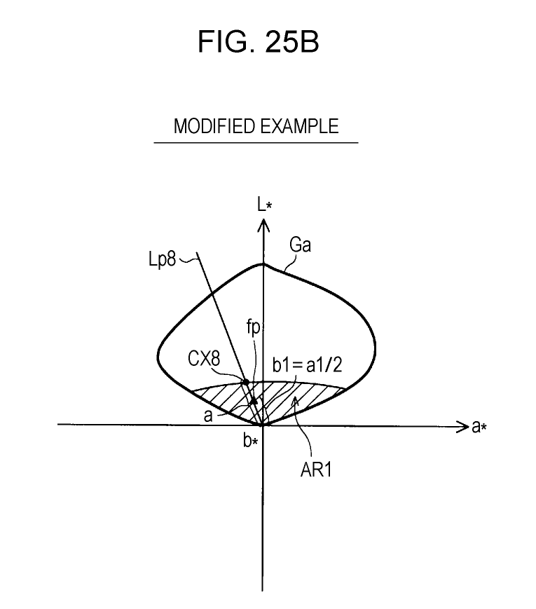

FIGS. 25A and 25B are explanatory diagrams schematically showing a method of setting the metallic ink amount for the lattice point included in the metallic ink reduced region according to the modified example 13. In FIGS. 25A and 25B, FIG. 25A shows a relationship between L* and the metallic ink amount Sv (duty) at each lattice point while FIG. 25B schematically shows a method of determining the metallic ink amount Sv for one lattice point fp as an example. In FIG. 25A, the relationship between L* at each lattice point (each reference point in the LUT reconstructed in Step S225) and the metallic ink amount Sv (duty) in the fifth embodiment is shown by a broken line. In the modified example 13, metallic ink amount Sv is not set to a predetermined value for the lattice point included in the metallic ink reduced region as shown in FIG. 25A unlike in the fifth to seventh embodiment. Specifically, the metallic ink amount Sv is set for the lattice point included in the metallic ink reduced region such that L* and the metallic ink amount Sv are linear-proportional to each other with the upper limit of 30%.

When the intersection between a straight line Lp8 connecting a certain lattice point fp and the origin of the L*a*b* color space and the metallic ink reduced region AR1 is the intersection CX8 as shown in FIG. 25B, for example, the difference in brightness between the origin and the intersection CX8 correspond to the difference in brightness (namely, F0) between the origin (brightness 0) in FIGS. 25B and F0 as L* at a border of the region in which the metallic ink amount Sv is increased and the region in which the duty of the metallic ink amount Sv is constantly 30%. Therefore, when the distance b1 between the origin and the lattice point fp is a half of the distance a1 between the origin and the intersection CX8 as shown in FIG. 25B, for example, metallic ink amount Sv at the lattice point fp is set to the duty of “15%” which is the duty at the lattice point at which L* is F0/2 as shown in FIG. 25A.

Even with such configurations, it is possible to achieve the same effects as those in the fifth to seventh embodiment. It is also possible to employ a configuration in which L* and the metallic ink amount Sv are in an arbitrary relationship such as a relationship according to which the metallic ink amount Sv is increased in an exponential fashion as L* is increased instead of the configuration in which L* and the metallic ink amount Sv (ink duty) are in the relationship of the linear proportion, within the range in which the L* value is from 0 to F0 as shown in FIG. 25A. In addition, it is possible to set the metallic ink amount Sv not to a constant value of 30% but to an arbitrary value even for the lattice point which is not included in the metallic ink reduced region AR1. For example, it is possible to employ a configuration in which the metallic ink amount Sv is set to a constant value of 35% for such a lattice point or a configuration in which the metallic ink amount Sv is set to become large as L* is increased.

### H14. Modified Example 14

In the fifth to seventh embodiment, the metallic ink reduced region is set in the L*a*b* color space. However, it is also possible to set the L*a*b* color space in an arbitrary color space which does not depend on the device, such as an L*C*h color space, an XYZ color space, or the like instead of the L*a*b* color space.

### H15. Modified Example 15

In the fifth embodiment, it is also possible to add a condition that the L* value at the center point C0 of the ellipsoidal spherical shape EL is set to a negative value when the ellipsoidal spherical shape EL is determined. If the L* value at the center point C0 is a positive value, the ellipsoidal spherical shape EL is not present near the lower end of the color gamut Ga, and the region in which the color gamut Ga and the inside of the ellipsoidal spherical shape EL are not overlapped with each other may occur when the radius in the L* direction of the ellipsoidal spherical shape EL is short. In such a case, L* does not correspond to the metallic ink reduced region AR1 although the L* value is small. Therefore, there is a concern that the pixels for which the metallic ink amount Sv is set to the duty of 30% may be present and the brightness inversion phenomenon may occur. Thus, it is possible to suppress the occurrence of the brightness inversion phenomenon by adding the condition that the L* value at the center point C0 of the circular-shape is set to a negative value.

### H16. Modified Example 16

In Step S275 in the LUT creating processing in the fifth to seventh embodiment, the metallic ink amount Sv is added to the lattice point belonging to the metallic ink reduced region. However, it is also possible to change the color ink amount (duty) for the lattice point which does not belong to the metallic ink reduced region instead of the above configuration. As described above, the existing LUT referred to when the LUT 62 is created is a LUT created by reducing the ink duty restriction value of the color ink by the amount by which the metallic ink S is superimposed. Accordingly, the lattice point which does not belong to the metallic ink reduced region is converted into a color obtained by reducing the amount of the color ink as compared with the case where the color conversion is performed with the use of the ordinary LUT. Thus, it is preferable to increase the amount of the color ink (duty) for the lattice point which does not belong to the metallic ink reduced region. On the other hand, it is also possible to employ a configuration in which the ink duty restriction value for the color ink is reduced and the metal ink amount Sv is added for the lattice point belonging to the metallic ink reduced region with the use of the ordinary LUT in which the ink duty restriction value for the color ink is not reduced, as the LUT referred to when the LUT 62 is created.

### H17. Modified Example 17

In each embodiment, a part of the configurations realized by the software may be replaced with hardware. On the other hand, a part of the configurations realized by the hardware may be replaced with software.

What is claimed is:

1. A printing apparatus which prints an image with the use of a luster agent and a colorant, comprising:
a color conversion unit which converts a color of an image into a printed color expressed by the luster agent and the colorant such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

2. The printing apparatus according to claim 1,
wherein the color conversion unit converts the color of the image into the printed color with the use of a color conversion LUT which sets the degree of change in brightness with respect to the gradation change for the pixels with the index values which belong to the highlighted part to be larger than that for the pixels with the index values which do not belong to the highlighted region, among the pixels constituting the image.

3. The printing apparatus according to claim 1,
wherein the color conversion unit includes:
a brightness adjustment unit which sets the degree of change in brightness with respect to the gradation change for the pixels with index values which belong to the highlighted region to be larger than that for the pixels with index values which do not belong to the highlighted region, among the pixels constituting the image;
a color conversion LUT which associates the color of the image with the printed color; and
a conversion unit which converts the color of the image which has been adjusted by the brightness adjustment unit into the printed color with the use of the color conversion LUT.

4. The printing apparatus according to claim 1,
wherein the color conversion unit converts the color of the image into the printed color such that an amount of the luster agent for pixels belonging to a shadow part in which the index values are equal to or less than a second predetermined value which is less than the first predetermined value is smaller than that for the pixels with the index values which do not belong to the shadow part, among the pixels constituting the image.

5. A printing apparatus which prints an image with the use of a luster agent and a colorant, comprising:
a color conversion unit which converts a color of an image into a printed color expressed by the luster agent and the colorant such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

6. The printing apparatus according to claim 5,
wherein the color conversion unit converts the color of the image into the printed color with the use of a color conversion LUT which sets the degree of change in saturation with respect to the gradation change for the low saturation pixels to be larger than that for the pixels with the index values which do not belong to the highlighted region, among the pixels constituting the image.

7. The printing apparatus according to claim 5,
wherein the color conversion unit includes:
a saturation adjustment unit which sets the degree of change in saturation with respect to the gradation change for the low saturation pixels to be larger than that for the pixels with index values which do not belong to the highlighted region, among the pixels constituting the image;
a color conversion LUT which associates the color of the image with the printed color; and
a conversion unit which converts the color of the image which has been adjusted by the saturation adjustment unit into the printed color with the use of the color conversion LUT.

8. The printing apparatus according to claim 5,
wherein the color conversion unit converts the color of the image into the printed color such that an amount of the luster agent for pixels belonging to a shadow part in which the index values are equal to or less than a second predetermined value which is less than the first predetermined value is smaller than that for the pixels with the index values which do not belong to the shadow part, among the pixels constituting the image.

9. A printing control apparatus which controls a printing apparatus which prints an image with the use of a luster agent and a colorant, the printing control apparatus comprising:
a color conversion unit which converts a color of an image into a printed color expressed by the luster agent and the colorant such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

10. A printing control apparatus which controls a printing apparatus which prints an image with the use of a luster agent and a colorant, the printing control apparatus comprising:
a color conversion unit which converts a color of an image into a printed color expressed by the luster agent and the colorant such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

11. A color conversion method by which a color of an image is converted into a printed color expressed by a luster agent and a colorant used in a printing apparatus, the method comprising:
converting a color of an image into a printed color such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

12. A color conversion method by which a color of an image is converted into a printed color expressed by a luster agent and a colorant used in a printing apparatus, the method comprising:
converting a color of an image into a printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.

13. A computer readable recording medium which records program by which a color of an image is converted into a printed color expressed by a luster agent and a colorant used in a printing apparatus, the program causing a computer to execute:
converting a color of an image into a printed color such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

14. A computer readable recording medium which records program by which a color of an image is converted into a printed color expressed by a luster agent and a colorant used in a printing apparatus, the program causing a computer to execute:
converting a color of an image into a printed color such that a degree of change in saturation with respect to a gradation change for low saturation pixels, which are pixels belonging to a highlighted part in which index values relating to brightness are equal to or greater than a first predetermined value, whose saturation is equal to or less than a predetermined value, is larger than that for pixels with index values which do not belong to the highlighted part, among the pixels constituting the image.
